(19) United States
(12) Patent Application Publication
(10) Pub. No.: US 2025/0203571 A1
(43) Pub. Date: Jun. 19, 2025

(54) POSITION ESTIMATION OF A USER EQUIPMENT VIA A WIRELESS NODE ASSOCIATED WITH MULTIPLE AREA IDENTIFIERS

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 18/848,489

(22) PCT Filed: Mar. 30, 2023
(86) PCT No.: PCT/US2023/016906

§ 371 Date: Sep. 18, 2024

(30) Foreign Application Priority Data
May 20, 2022 (GR) 20220100421

(51) Int. Cl. H04W 64/00; H04W 76/10

(52) U.S. Cl. CPC H04W 64/006; H04W 76/10

(57) ABSTRACT

Disclosed are techniques for wireless communication. In an aspect, position estimation of a user equipment (UE) is performed via a wireless node (e.g., gNB or TRP or RU, UE in case of sidelink, etc.) associated with multiple area identifiers.

### CROSS-REFERENCE TO RELATED APPLICATIONS

The present Application for Patent claims priority to Greek patent application No. 20220100421, entitled “POSITION ESTIMATION OF A USER EQUIPMENT VIA A WIRELESS NODE ASSOCIATED WITH MULTIPLE AREA IDENTIFIERS,” filed May 20, 2022, and is a national stage application, filed under 35 U.S.C. § 371, of International Patent Application No. PCT/US2023/016906, entitled “POSITION ESTIMATION OF A USER EQUIPMENT VIA A WIRELESS NODE ASSOCIATED WITH MULTIPLE AREA IDENTIFIERS,” filed Mar. 30, 2023, both of which are assigned to the assignee hereof and expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of operating a user equipment (UE) includes receiving assistance data for positioning that includes indications of at least a first candidate group of wireless nodes for positioning of the UE and a second candidate group of wireless nodes for positioning of the UE, the first candidate group of wireless nodes for positioning of the UE associated with a first area identifier (ID) and the second candidate group of wireless nodes for positioning of the UE associated with a second area ID; establishing a connection with a wireless node associated with the first area ID and the second area ID; selecting at least one of the first area ID and the second area ID based on one or more selection parameters; and performing a position estimation procedure associated with reference signals for positioning (RS-Ps) with two or more wireless nodes associated with the selected at least one area ID.

In an aspect, a method of operating a network component includes determining assistance data for positioning that includes indications of at least a first second candidate group of wireless nodes for positioning of a user equipment (UE) and a second candidate group of wireless nodes for positioning of the UE, the first candidate group of wireless nodes for positioning of the UE associated with a first area identifier (ID) and the second candidate group of wireless nodes for positioning of the UE associated with a second area ID; determining one or more selection parameters associated with UE-based area ID selection; transmitting, to the UE, the assistance data for positioning and the one or more selection parameters; and receiving a report comprising measurement information associated with a position estimation procedure, wherein the report is based on the assistance data for positioning and the one or more selection parameters.

In an aspect, a user equipment (UE) includes a memory; at least one transceiver; and at least one processor communicatively coupled to the memory and the at least one transceiver, the at least one processor configured to: receive, via the at least one transceiver, assistance data for positioning that includes indications of at least a first candidate group of wireless nodes for positioning of the UE and a second candidate group of wireless nodes for positioning of the UE, the first candidate group of wireless nodes for positioning of the UE associated with a first area identifier (ID) and the second candidate group of wireless nodes for positioning of the UE associated with a second area ID; establish a connection with a wireless node associated with the first area ID and the second area ID; select at least one of the first area ID and the second area ID based on one or more selection parameters; and perform a position estimation procedure associated with reference signals for positioning (RS-Ps) with two or more wireless nodes associated with the selected at least one area ID.

In an aspect, a network component includes a memory; at least one transceiver; and at least one processor communicatively coupled to the memory and the at least one transceiver, the at least one processor configured to: determine assistance data for positioning that includes indications of at least a first second candidate group of wireless nodes for positioning of a user equipment (UE) and a second candidate group of wireless nodes for positioning of the UE, the first candidate group of wireless nodes for positioning of the UE associated with a first area identifier (ID) and the second candidate group of wireless nodes for positioning of the UE associated with a second area ID; determine one or more selection parameters associated with UE-based area ID selection; transmit, via the at least one transceiver, to the UE, the assistance data for positioning and the one or more selection parameters; and receive, via the at least one transceiver, a report comprising measurement information associated with a position estimation procedure, wherein the report is based on the assistance data for positioning and the one or more selection parameters.

In an aspect, a user equipment (UE) includes means for receiving assistance data for positioning that includes indications of at least a first candidate group of wireless nodes for positioning of the UE and a second candidate group of wireless nodes for positioning of the UE, the first candidate group of wireless nodes for positioning of the UE associated with a first area identifier (ID) and the second candidate group of wireless nodes for positioning of the UE associated with a second area ID; means for establishing a connection with a wireless node associated with the first area ID and the second area ID; means for selecting at least one of the first area ID and the second area ID based on one or more selection parameters; and means for performing a position estimation procedure associated with reference signals for positioning (RS-Ps) with two or more wireless nodes associated with the selected at least one area ID.

In an aspect, a network component includes means for determining assistance data for positioning that includes indications of at least a first second candidate group of wireless nodes for positioning of a user equipment (UE) and a second candidate group of wireless nodes for positioning of the UE, the first candidate group of wireless nodes for positioning of the UE associated with a first area identifier (ID) and the second candidate group of wireless nodes for positioning of the UE associated with a second area ID; means for determining one or more selection parameters associated with UE-based area ID selection; means for transmitting, to the UE, the assistance data for positioning and the one or more selection parameters; and means for receiving a report comprising measurement information associated with a position estimation procedure, wherein the report is based on the assistance data for positioning and the one or more selection parameters.

In an aspect, a non-transitory computer-readable medium storing computer-executable instructions that, when executed by a user equipment (UE), cause the UE to: receive assistance data for positioning that includes indications of at least a first candidate group of wireless nodes for positioning of the UE and a second candidate group of wireless nodes for positioning of the UE, the first candidate group of wireless nodes for positioning of the UE associated with a first area identifier (ID) and the second candidate group of wireless nodes for positioning of the UE associated with a second area ID; establish a connection with a wireless node associated with the first area ID and the second area ID; select at least one of the first area ID and the second area ID based on one or more selection parameters; and perform a position estimation procedure associated with reference signals for positioning (RS-Ps) with two or more wireless nodes associated with the selected at least one area ID.

In an aspect, a non-transitory computer-readable medium storing computer-executable instructions that, when executed by a network component, cause the network component to: determine assistance data for positioning that includes indications of at least a first second candidate group of wireless nodes for positioning of a user equipment (UE) and a second candidate group of wireless nodes for positioning of the UE, the first candidate group of wireless nodes for positioning of the UE associated with a first area identifier (ID) and the second candidate group of wireless nodes for positioning of the UE associated with a second area ID; determine one or more selection parameters associated with UE-based area ID selection; transmit, to the UE, the assistance data for positioning and the one or more selection parameters; and receive a report comprising measurement information associated with a position estimation procedure, wherein the report is based on the assistance data for positioning and the one or more selection parameters.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure, according to aspects of the disclosure.

FIG. 5 is a diagram illustrating various downlink channels within an example downlink slot, according to aspects of the disclosure.

FIG. 6 is a diagram illustrating various uplink channels within an example uplink slot, according to aspects of the disclosure.

FIGS. 7A and 7B are diagrams of example sidelink slot structures with and without feedback resources, according to aspects of the disclosure.

FIG. 8 is a diagram of an example positioning reference signal (PRS) configuration for the PRS transmissions of a given base station, according to aspects of the disclosure.

FIG. 9 is a diagram of example positioning reference signal (PRS) resource repetition and beam sweeping options, according to aspects of the disclosure.

FIG. 10 is a diagram illustrating an example downlink positioning reference signal (DL-PRS) configuration for two transmission-reception points (TRPs) operating in the same positioning frequency layer, according to aspects of the disclosure.

FIG. 11 is a diagram illustrating an example resource pool for positioning within a sidelink resource pool, according to aspects of the disclosure.

FIG. 12 illustrates examples of various positioning methods supported in New Radio (NR), according to aspects of the disclosure.

FIGS. 13A and 13B illustrate various scenarios of interest for sidelink-only or joint Uu and sidelink positioning, according to aspects of the disclosure.

FIG. 14 illustrates an example Long-Term Evolution (LTE) positioning protocol (LPP) call flow between a UE and a location server for performing positioning operations.

FIG. 15 illustrates an area identifier (ID) arrangement, in accordance with aspects of the disclosure.

FIG. 16 illustrates an exemplary process of communications according to an aspect of the disclosure.

FIG. 17 illustrates an exemplary process of communications according to an aspect of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

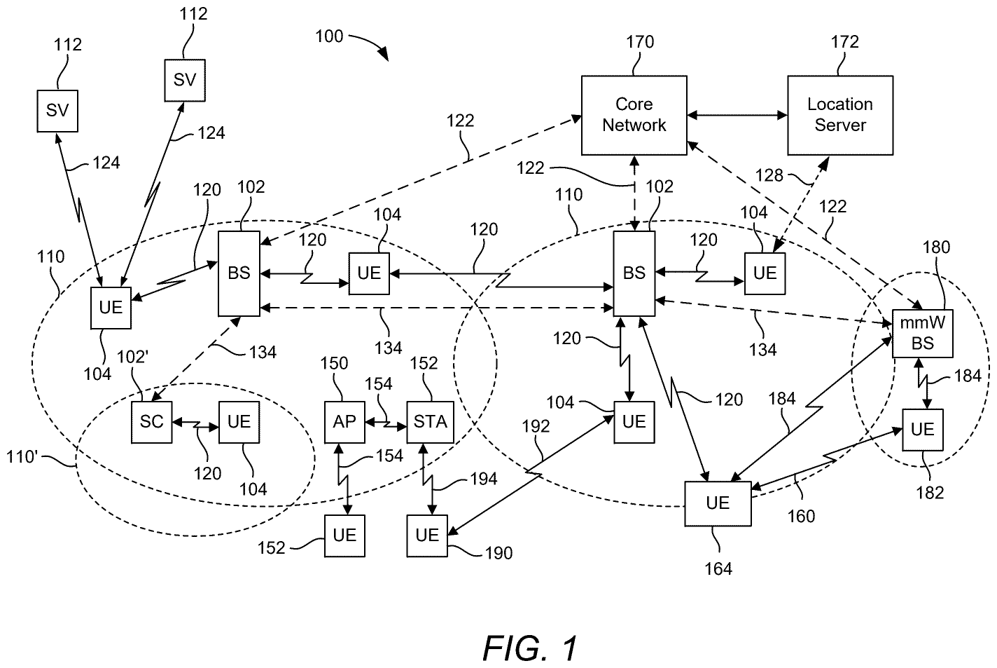

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHZ, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mm W or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHZ-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

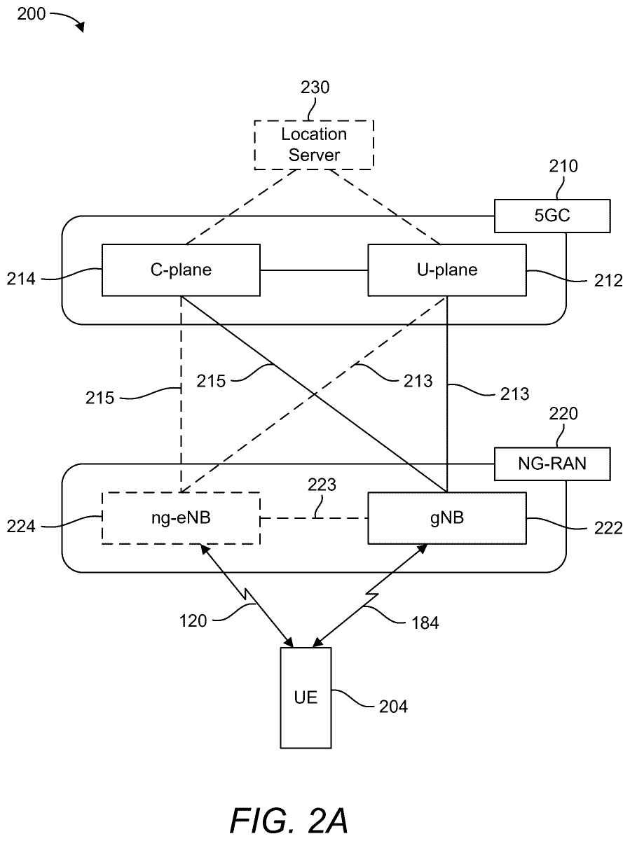

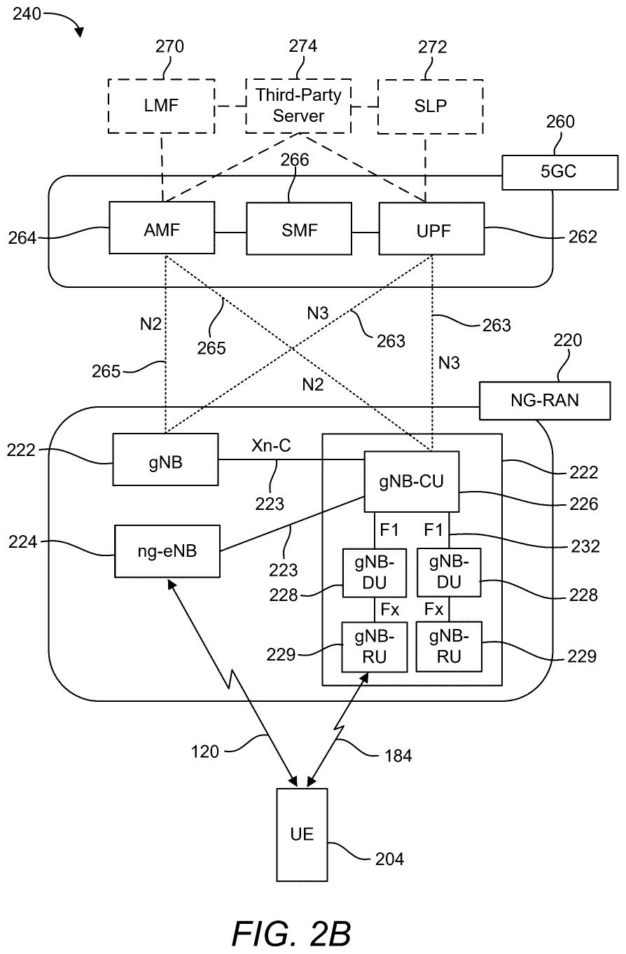

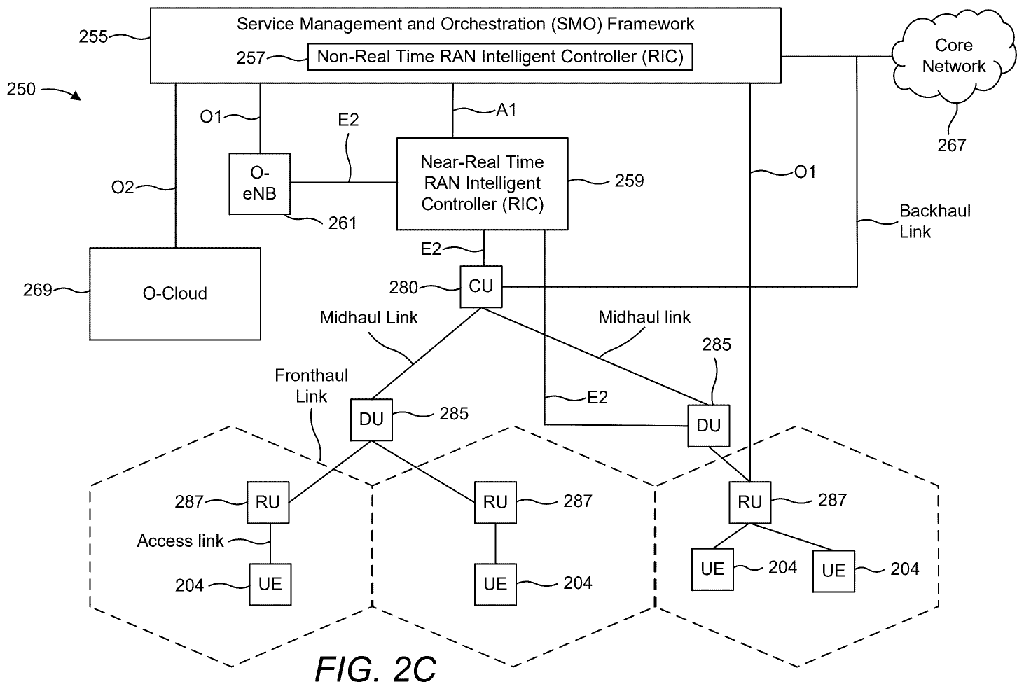

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more distributed units (DUs) 285 (e.g., gNB-DUs 228) via respective midhaul links, such as an F1 interface. The DUs 285 may communicate with one or more radio units (RUS) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUs 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 280 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via 01) or via creation of RAN management policies (such as A1 policies).

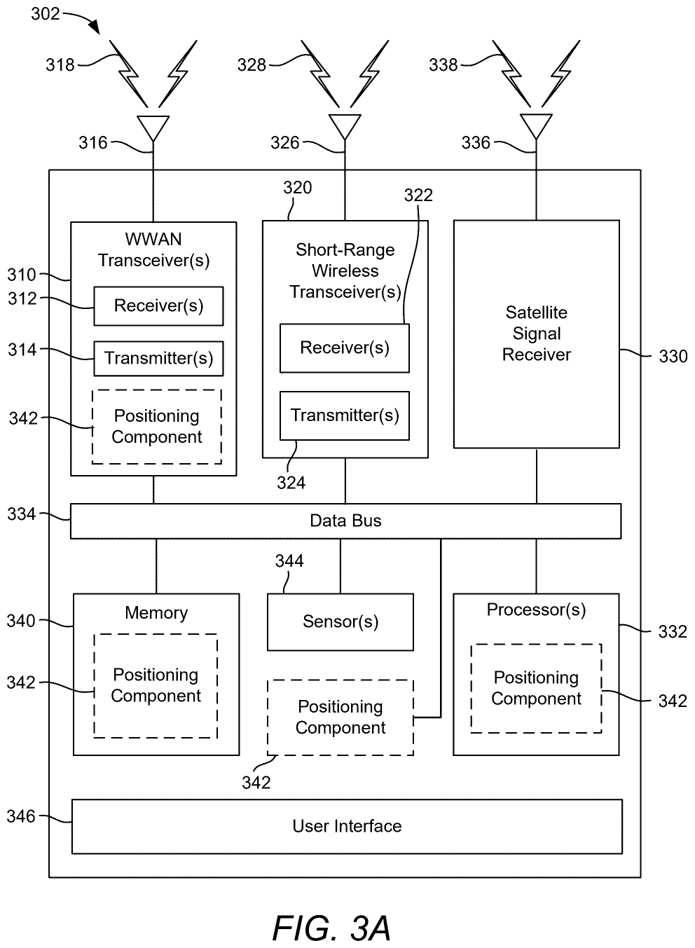

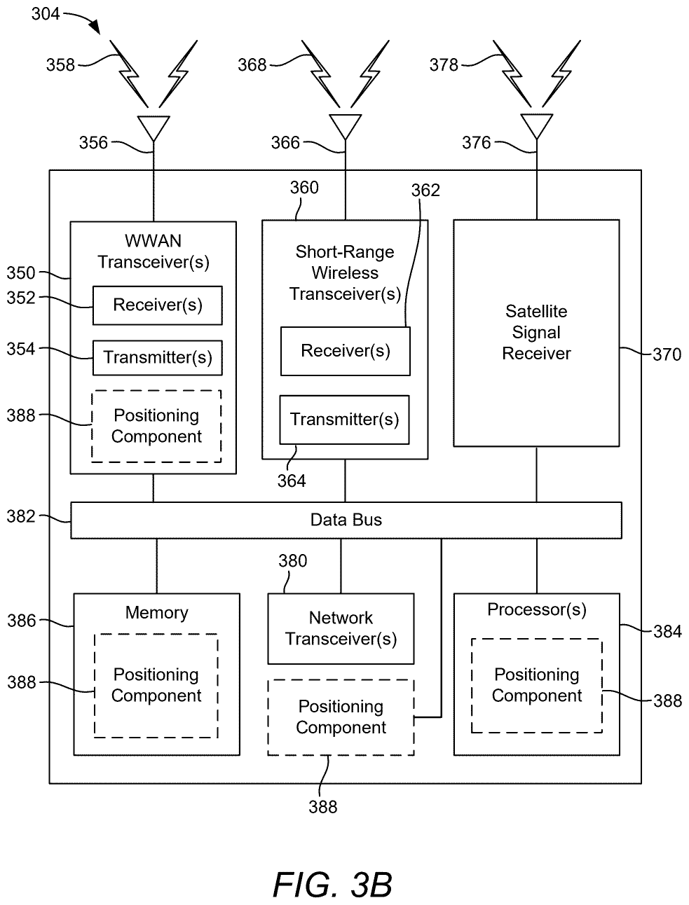

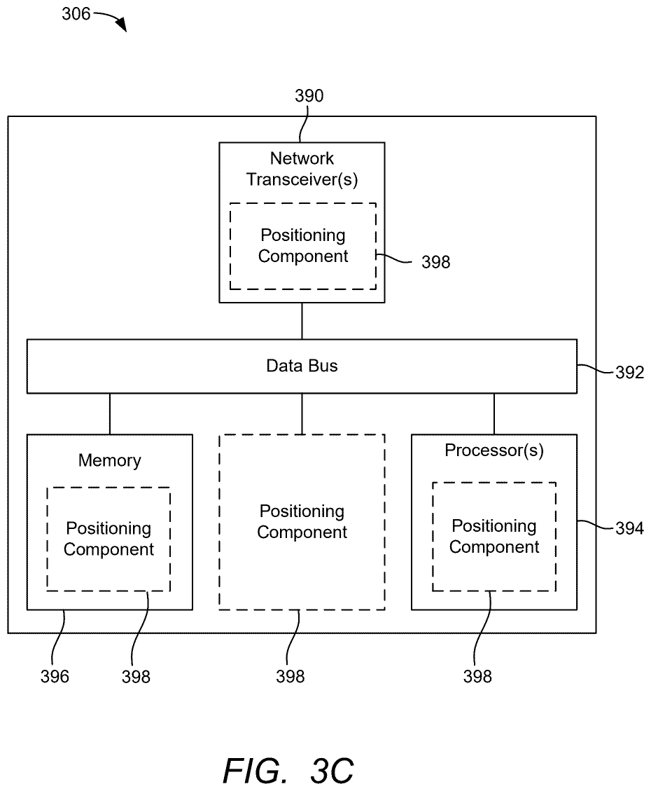

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components.

For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-WaveR transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

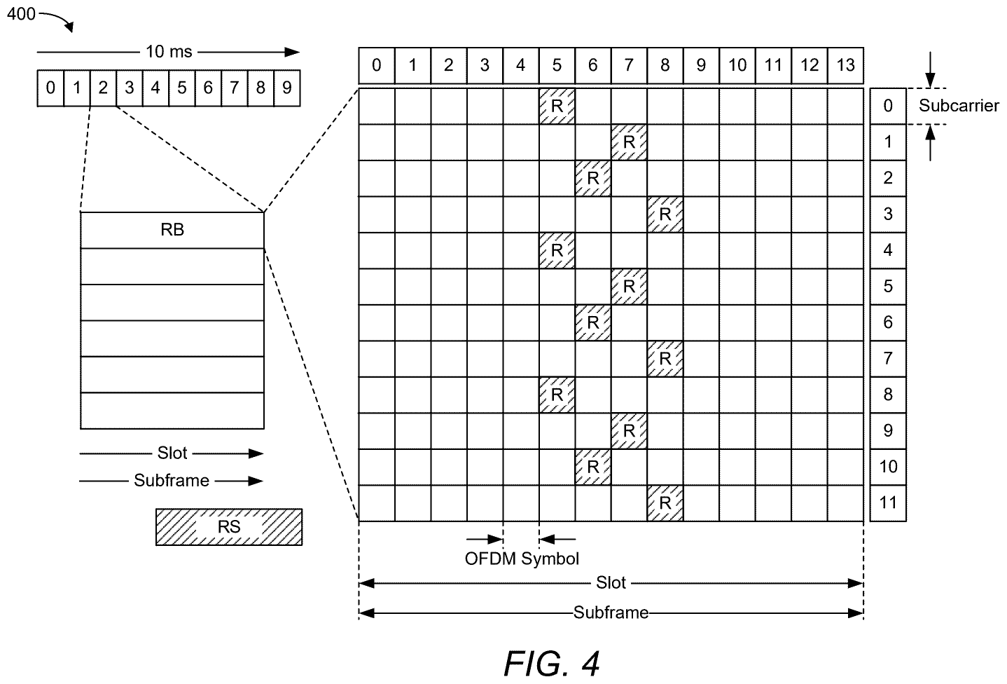

Various frame structures may be used to support downlink and uplink transmissions between network nodes (e.g., base stations and UEs). FIG. 4 is a diagram 400 illustrating an example frame structure, according to aspects of the disclosure. The frame structure may be a downlink or uplink frame structure. Other wireless communications technologies may have different frame structures and/or different channels.

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

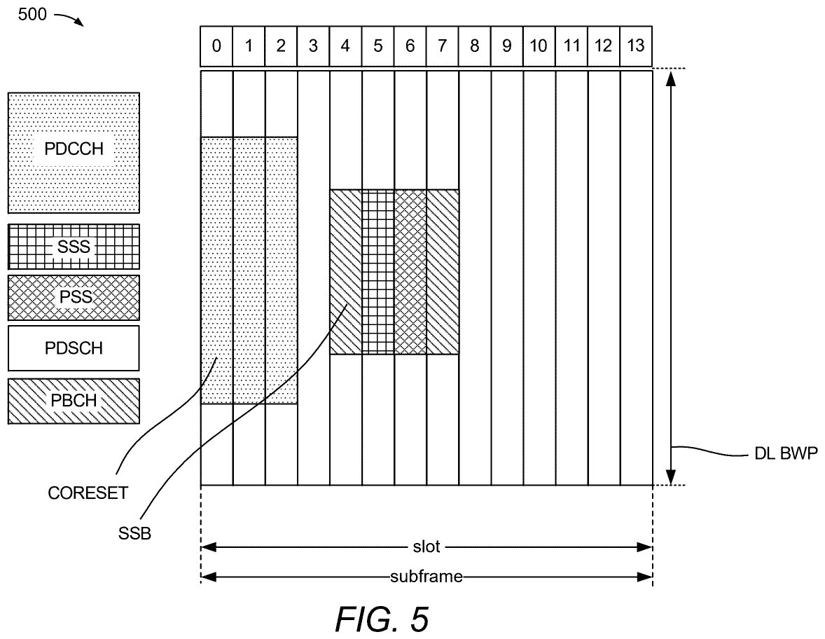

FIG. 5 is a diagram 500 illustrating various downlink channels within an example downlink slot. In FIG. 5, time is represented horizontally (on the X axis) with time increasing from left to right, while frequency is represented vertically (on the Y axis) with frequency increasing (or decreasing) from bottom to top. In the example of FIG. 5, a numerology of 15 kHz is used. Thus, in the time domain, the illustrated slot is one millisecond (ms) in length, divided into 14 symbols.

In NR, the channel bandwidth, or system bandwidth, is divided into multiple bandwidth parts (BWPs). A BWP is a contiguous set of RBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 5, a primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries a master information block (MIB), may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

The physical downlink control channel (PDCCH) carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 5, there is one CORESET per BWP, and the CORESET spans three symbols (although it may be only one or two symbols) in the time domain. Unlike LTE control channels, which occupy the entire system bandwidth, in NR, PDCCH channels are localized to a specific region in the frequency domain (i.e., a CORESET). Thus, the frequency component of the PDCCH shown in FIG. 5 is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE, referred to as uplink and downlink grants, respectively. More specifically, the DCI indicates the resources scheduled for the downlink data channel (e.g., PDSCH) and the uplink data channel (e.g., physical uplink shared channel (PUSCH)). Multiple (e.g., up to eight) DCIs can be configured in the PDCCH, and these DCIs can have one of multiple formats. For example, there are different DCI formats for uplink scheduling, for downlink scheduling, for uplink transmit power control (TPC), etc. A PDCCH may be transported by 1, 2, 4, 8, or 16 CCEs in order to accommodate different DCI payload sizes or coding rates.

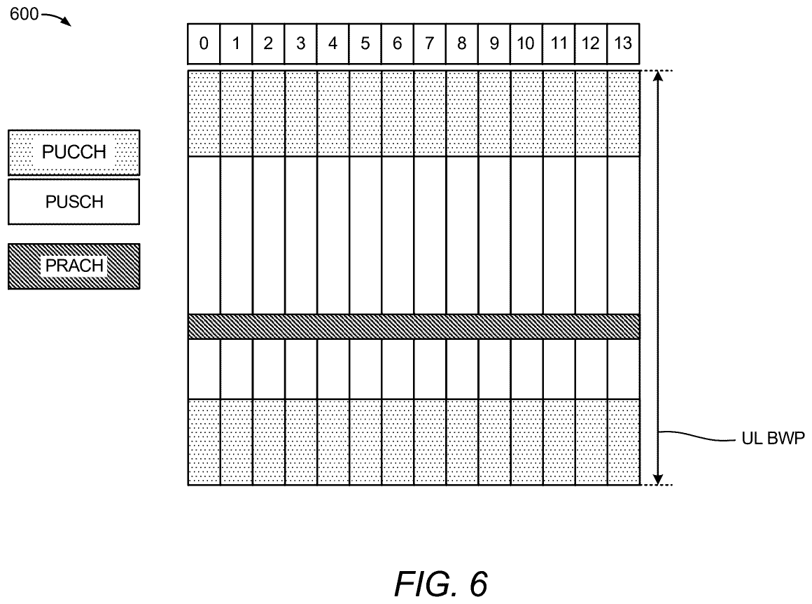

FIG. 6 is a diagram 600 illustrating various uplink channels within an example uplink slot. In FIG. 6, time is represented horizontally (on the X axis) with time increasing from left to right, while frequency is represented vertically (on the Y axis) with frequency increasing (or decreasing) from bottom to top. In the example of FIG. 6, a numerology of 15 kHz is used. Thus, in the time domain, the illustrated slot is one millisecond (ms) in length, divided into 14 symbols.

A random-access channel (RACH), also referred to as a physical random-access channel (PRACH), may be within one or more slots within a frame based on the PRACH configuration. The PRACH may include six consecutive RB pairs within a slot. The PRACH allows the UE to perform initial system access and achieve uplink synchronization. A physical uplink control channel (PUCCH) may be located on edges of the uplink system bandwidth. The PUCCH carries uplink control information (UCI), such as scheduling requests, CSI reports, a channel quality indicator (CQI), a precoding matrix indicator (PMI), a rank indicator (RI), and HARQ ACK/NACK feedback. The physical uplink shared channel (PUSCH) carries data, and may additionally be used to carry a buffer status report (BSR), a power headroom report (PHR), and/or UCI.

Sidelink communication takes place in transmission or reception resource pools. In the frequency domain, the minimum resource allocation unit is a sub-channel (e.g., a collection of consecutive PRBs in the frequency domain). In the time domain, resource allocation is in one slot intervals. However, some slots are not available for sidelink, and some slots contain feedback resources. In addition, sidelink resources can be (pre) configured to occupy fewer than the 14 symbols of a slot.

Sidelink resources are configured at the radio resource control (RRC) layer. The RRC configuration can be by pre-configuration (e.g., preloaded on the UE) or configuration (e.g., from a serving base station).

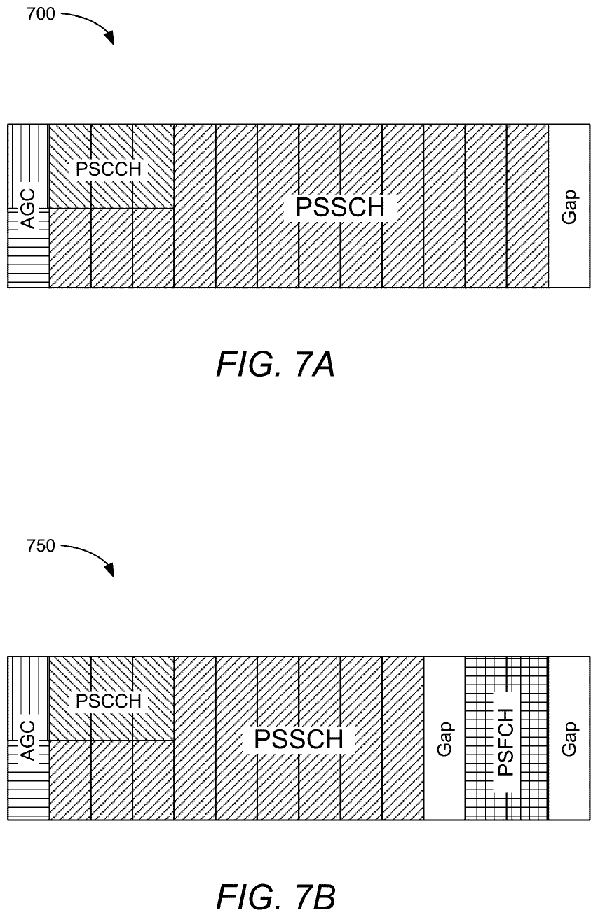

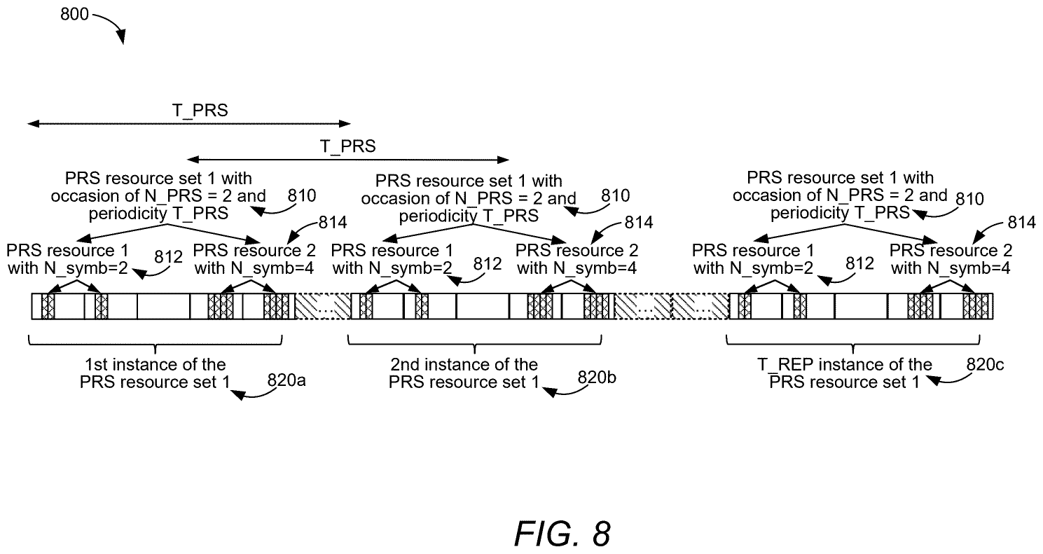

NR sidelinks support hybrid automatic repeat request (HARQ) retransmission. FIG. 7A is a diagram 700 of an example slot structure without feedback resources, according to aspects of the disclosure. In the example of FIG. 7A, time is represented horizontally and frequency is represented vertically. In the time domain, the length of each block is one orthogonal frequency division multiplexing (OFDM) symbol, and the 14 symbols make up a slot. In the frequency domain, the height of each block is one sub-channel. Currently, the (pre) configured sub-channel size can be selected from the set of {10, 15, 20, 25, 50, 75, 100} physical resource blocks (PRBs).

For a sidelink slot, the first symbol is a repetition of the preceding symbol and is used for automatic gain control (AGC) setting. This is illustrated in FIG. 7A by the vertical and horizontal hashing. As shown in FIG. 7A, for sidelink, the physical sidelink control channel (PSCCH) and the physical sidelink shared channel (PSSCH) are transmitted in the same slot. Similar to the physical downlink control channel (PDCCH), the PSCCH carries control information about sidelink resource allocation and descriptions about sidelink data transmitted to the UE. Likewise, similar to the physical downlink shared channel (PDSCH), the PSSCH carries user date for the UE. In the example of FIG. 7A, the PSCCH occupies half the bandwidth of the sub-channel and only three symbols. Finally, a gap symbol is present after the PSSCH.

FIG. 7B is a diagram 750 of an example slot structure with feedback resources, according to aspects of the disclosure. In the example of FIG. 7B, time is represented horizontally and frequency is represented vertically. In the time domain, the length of each block is one OFDM symbol, and the 14 symbols make up a slot. In the frequency domain, the height of each block is one sub-channel.

The slot structure illustrated in FIG. 7B is similar to the slot structure illustrated in FIG. 7A, except that the slot structure illustrated in FIG. 7B includes feedback resources. Specifically, two symbols at the end of the slot have been dedicated to the physical sidelink feedback channel (PSFCH). The first PSFCH symbol is a repetition of the second PSFCH symbol for AGC setting. In addition to the gap symbol after the PSSCH, there is a gap symbol after the two PSFCH symbols. Currently, resources for the PSFCH can be configured with a periodicity selected from the set of {0, 1, 2, 4} slots.

FIG. 8 is a diagram of an example PRS configuration 800 for the PRS transmissions of a given base station, according to aspects of the disclosure. In FIG. 8, time is represented horizontally, increasing from left to right. Each long rectangle represents a slot and each short (shaded) rectangle represents an OFDM symbol. In the example of FIG. 8, a PRS resource set 810 (labeled “PRS resource set 1”) includes two PRS resources, a first PRS resource 812 (labeled “PRS resource 1”) and a second PRS resource 814 (labeled “PRS resource 2”). The base station transmits PRS on the PRS resources 812 and 814 of the PRS resource set 810.

The PRS resource set 810 has an occasion length (N_PRS) of two slots and a periodicity (T_PRS) of, for example, 160 slots or 160 milliseconds (ms) (for 15 kHz subcarrier spacing). As such, both the PRS resources 812 and 814 are two consecutive slots in length and repeat every T_PRS slots, starting from the slot in which the first symbol of the respective PRS resource occurs. In the example of FIG. 8, the PRS resource 812 has a symbol length (N_symb) of two symbols, and the PRS resource 814 has a symbol length (N_symb) of four symbols. The PRS resource 812 and the PRS resource 814 may be transmitted on separate beams of the same base station.

Each instance of the PRS resource set 810, illustrated as instances 820a, 820b, and 820c, includes an occasion of length ‘2’ (i.e., N_PRS=2) for each PRS resource 812, 814 of the PRS resource set. The PRS resources 812 and 814 are repeated every T_PRS slots up to the muting sequence periodicity T_REP. As such, a bitmap of length T_REP would be needed to indicate which occasions of instances 820a, 820b, and 820c of PRS resource set 810 are muted (i.e., not transmitted).

In an aspect, there may be additional constraints on the PRS configuration 800. For example, for all PRS resources (e.g., PRS resources 812, 814) of a PRS resource set (e.g., PRS resource set 810), the base station can configure the following parameters to be the same: (a) the occasion length (N_PRS), (b) the number of symbols (N_symb), (c) the comb type, and/or (d) the bandwidth. In addition, for all PRS resources of all PRS resource sets, the subcarrier spacing and the cyclic prefix can be configured to be the same for one base station or for all base stations. Whether it is for one base station or all base stations may depend on the UE's capability to support the first and/or second option.

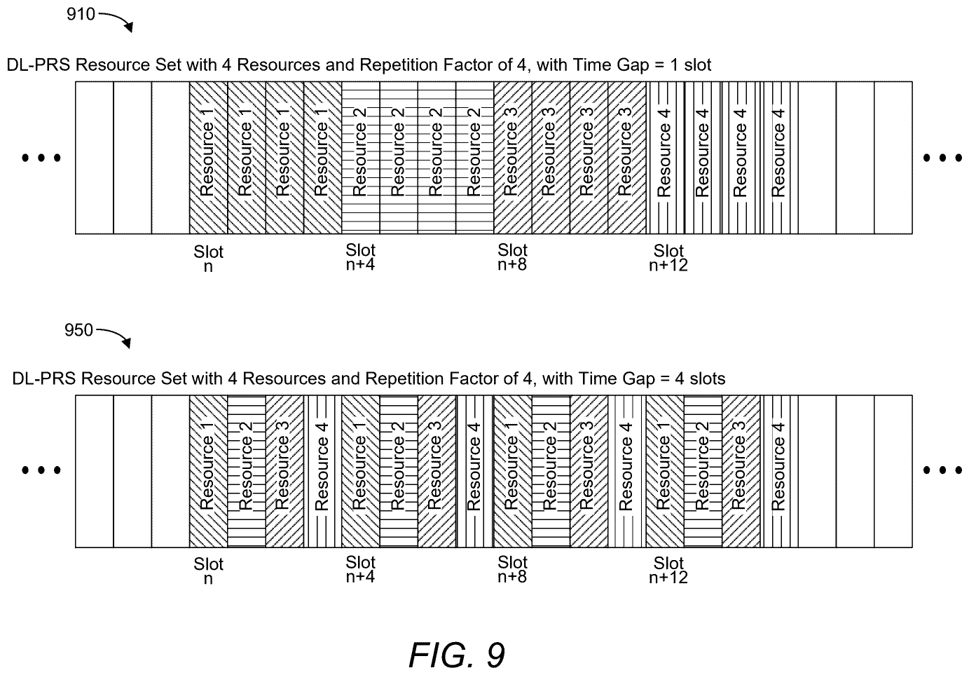

FIG. 9 is a diagram of example PRS resource repetition and beam sweeping options, according to aspects of the disclosure. In the example of FIG. 9, time is represented horizontally and frequency is represented vertically. Each block represents a slot in the time domain and some bandwidth in the frequency domain.

FIG. 9 illustrates instances (or occasions) of two DL-PRS resource set, a first DL-PRS resource set 910 and a second DL-PRS resource set 950. Each DL-PRS resource set 910 and 950 comprises four PRS resources (labeled “Resource 1,” “Resource 2,” “Resource 3,” and “Resource 4”) and has a repetition factor of four. A repetition factor of four means that each of the four PRS resources is repeated four times (i.e., is transmitted four times) within the DL-PRS resource set. That is, there are four repetitions of each of the four PRS resources within the DL-PRS resource set. The repetition factor may be configured to the UE by the higher layer parameter “PRS-ResourceRepetitionFactor,” and may have a value selected from the set {1, 2, 4, 6, 8, 16, 32}. Note that the time duration spanned by one DL-PRS resource set containing repeated DL-PRS resources, as illustrated in FIG. 9, should not exceed the PRS periodicity.

In the example of FIG. 9, the DL-PRS resource set 910 and the DL-PRS resource set 950 have different time gaps. The time gap is the offset in units of slots between two repeated instances of a DL-PRS resource corresponding to the same PRS resource ID within a single instance of a DL-PRS resource set. The time gap may be configured to the UE by the higher layer parameter “PRS-ResourceTimeGap,” and may have a value selected from the set {1, 2, 4, 8, 16, 32}.

In FIG. 9, the DL-PRS resource set 910 has a time gap of one slot, meaning that each repetition of a PRS resource (e.g., “Resource 1”) starts on the first slot after the previous repetition of that PRS resource. Thus, as illustrated for DL-PRS resource set 910, the four repetitions of each of the four PRS resources are grouped together. Specifically, the four repetitions of PRS resource “Resource 1” occupy the first four slots (i.e., slots n to n+3) of the DL-PRS resource set instance 910, the four repetitions of PRS resource “Resource 2” occupy the second four slots (i.e., slots n+4 to n+7), the four repetitions of PRS resource “Resource 3” occupy the third four slots (i.e., slots n+8 to n+11), and the four repetitions of PRS resource “Resource 4” occupy the last four slots (i.e., slots n+12 to n+15).

In contrast, the DL-PRS resource set 950 has a time gap of four slots, meaning that each repetition of a PRS resource (e.g., “Resource 2”) starts on the fourth slot after the previous repetition of that PRS resource. Thus, as illustrated by DL-PRS resource set instance 950, the four repetitions of each of the four PRS resources are scheduled every fourth slot. For example, the four repetitions of PRS resource “Resource 1” occupy the first, fifth, ninth, and thirteenth slots (i.e., slots n, n+4, n+8, and n+12) of the DL-PRS resource set 950.

The purposes of repetition of a PRS resource is to permit receive beam sweeping (e.g., by the UE) across the repetitions of the PRS resource, to enable the receiver to combine signal gains for coverage extension, and to allow for intra-instance muting (e.g., if one repetition is muted, there are still other repetitions for the receiver to measure). Note that UE receive beam sweeping is up to UE implementation.

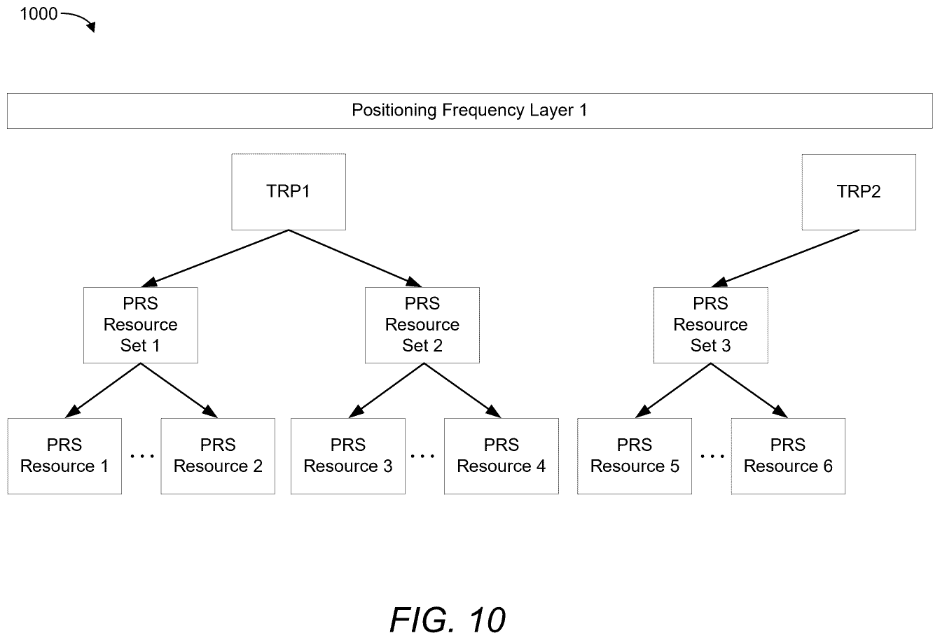

FIG. 10 is a diagram 1000 illustrating an example PRS configuration for two TRPs (labeled “TRP1” and “TRP2”) operating in the same positioning frequency layer (labeled “Positioning Frequency Layer 1”), according to aspects of the disclosure. For a positioning session, a UE may be provided with assistance data indicating the illustrated PRS configuration. In the example of FIG. 10, the first TRP (“TRP1”) is associated with (e.g., transmits) two PRS resource sets, labeled “PRS Resource Set 1” and “PRS Resource Set 2,” and the second TRP (“TRP2”) is associated with one PRS resource set, labeled “PRS Resource Set 3.” Each PRS resource set comprises at least two PRS resources. Specifically, the first PRS resource set (“PRS Resource Set 1”) includes PRS resources labeled “PRS Resource 1” and “PRS Resource 2,” the second PRS resource set (“PRS Resource Set 2”) includes PRS resources labeled “PRS Resource 3” and “PRS Resource 4,” and the third PRS resource set (“PRS Resource Set 3”) includes PRS resources labeled “PRS Resource 5” and “PRS Resource 6.”

Another aspect of sidelink positioning is the configuration of sidelink resource pools for positioning (RP-Ps). The 12 symbols between the first symbol of a sidelink slot (for AGC) and the last symbol (the gap) in the time domain and the allocated subchannel(s) in the frequency domain form a resource pool for sidelink transmission and/or reception. An RP-P can be configured within a resource pool specifically for positioning purposes. Each RP-P includes an offset, periodicity, number of consecutive symbols within a slot (e.g., as few as one symbol), and/or the bandwidth within a component carrier (or the bandwidth across multiple component carriers). In addition, each RP-P can be associated with a zone or a distance from a reference location.

A base station (or a UE) can assign, to another UE, one or more resource configurations from the RP-Ps. Additionally or alternatively, a UE (e.g., a relay or a remote UE) can request one or more RP-P configurations, and it can include in the request one or more of the following: (1) its location information (or zone identifier), (2) periodicity, (3) bandwidth, (4) offset, (5) number of symbols, and (6) whether a configuration with “low interference” is needed (which can be determined through an assigned quality of service (QoS) or priority).

A base station or a UE can configure/assign rate matching resources or RP-P for rate matching and/or muting to a sidelink UE such that when a collision exists between the assigned resources and another resource pool that contains data (PSSCH) and/or control (PSCCH), the sidelink UE is expected to rate match, mute, and/or puncture the data, DMRS, and/or CSI-RS within the colliding resources. This would enable orthogonalization between positioning and data transmissions for increased coverage of PRS signals.

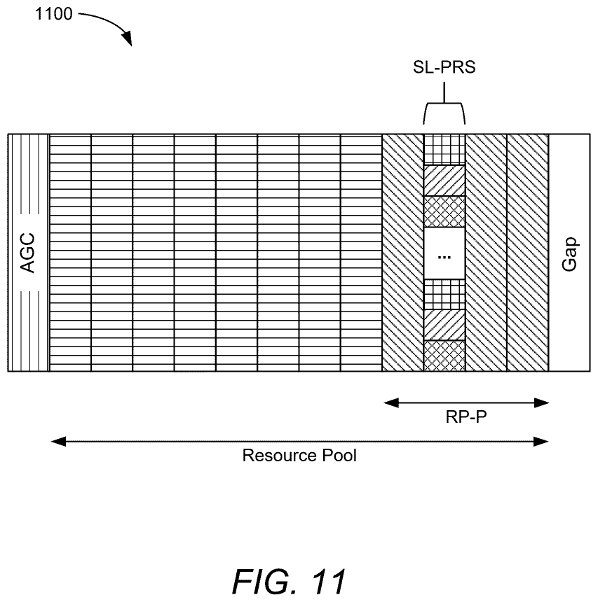

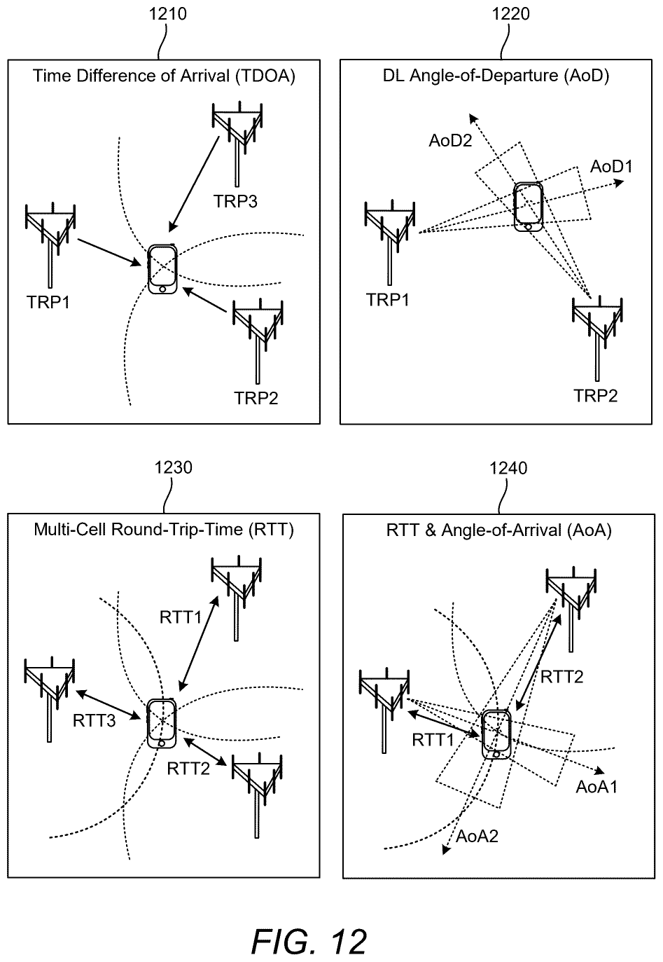

FIG. 11 is a diagram 1100 illustrating an example of a resource pool for positioning within a sidelink resource pool, according to aspects of the disclosure. In the example of FIG. 11, time is represented horizontally and frequency is represented vertically. In the time domain, the length of each block is an orthogonal frequency division multiplexing (OFDM) symbol, and the 14 symbols make up a slot. In the frequency domain, the height of each block is a sub-channel.

In the example of FIG. 11, the entire slot (except for the first and last symbols) can be a resource pool for sidelink transmission and/or reception. That is, any of the symbols other than the first and last can be allocated for transmission and/or reception. However, an RP-P for sidelink transmission/reception is allocated in the last four pre-gap symbols of the slot. As such, non-sidelink positioning data, such as user data, CSI-RS, and control information, can only be transmitted in the first eight post-AGC symbols and not in the last four pre-gap symbols to prevent a collision with the configured RP-P. The non-sidelink positioning data that would otherwise be transmitted in the last four pre-gap symbols can be punctured or muted, or the non-sidelink data that would normally span more than the eight post-AGC symbols can be rate matched to fit into the eight post-AGC symbols.

Sidelink positioning reference signals (SL-PRS) have been defined to enable sidelink positioning procedures among UEs. Like a downlink PRS (DL-PRS), an SL-PRS resource is composed of one or more resource elements (i.e., one OFDM symbol in the time domain and one subcarrier in the frequency domain). SL-PRS resources have been designed with a comb-based pattern to enable fast Fourier transform (FFT)-based processing at the receiver. SL-PRS resources are composed of unstaggered, or only partially staggered, resource elements in the frequency domain to provide small time of arrival (TOA) uncertainty and reduced overhead of each SL-PRS resource. SL-PRS may also be associated with specific RP-Ps (e.g., certain SL-PRS may be allocated in certain RP-Ps). SL-PRS have also been defined with intra-slot repetition (not shown in FIG. 11) to allow for combining gains (if needed). There may also be inter-UE coordination of RP-Ps to provide for dynamic SL-PRS and data multiplexing while minimizing SL-PRS collisions.

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 12 illustrates examples of various positioning methods, according to aspects of the disclosure. In an OTDOA or DL-TDOA positioning procedure, illustrated by scenario 1210, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 1220, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 1230, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 1240.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

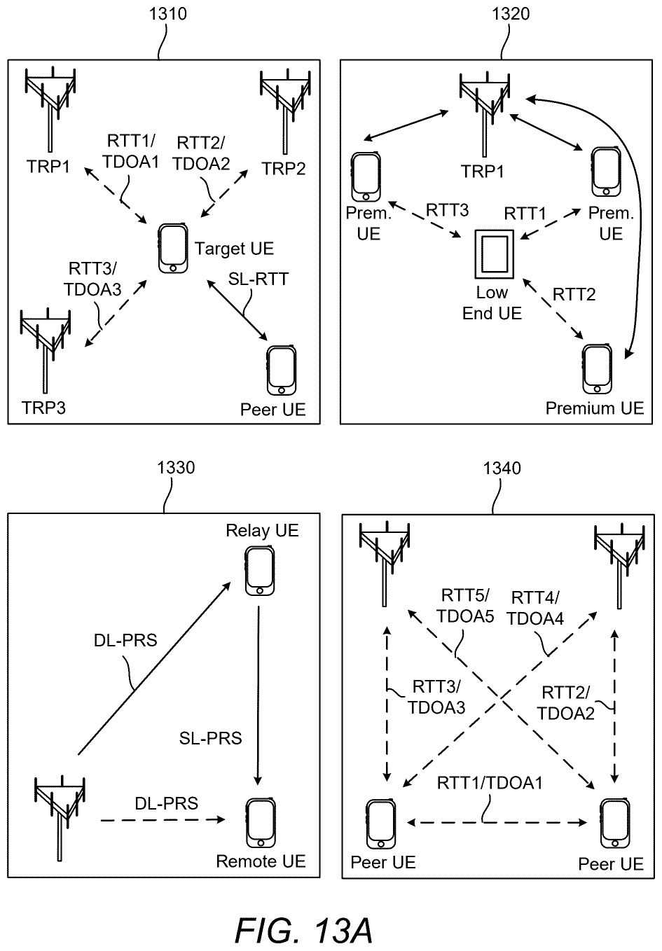

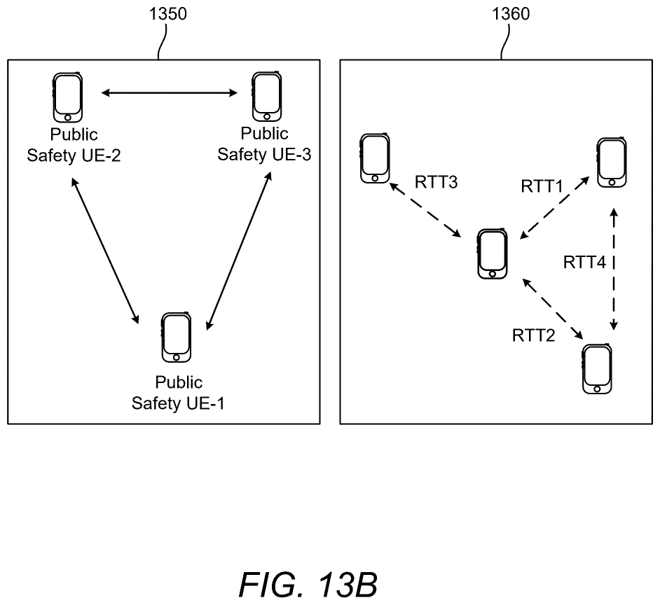

NR supports, or enables, various sidelink positioning techniques. FIG. 13A illustrates various scenarios of interest for sidelink-only or joint Uu and sidelink positioning, according to aspects of the disclosure. In scenario 1310, at least one peer UE with a known location can improve the Uu-based positioning (e.g., multi-cell round-trip-time (RTT), downlink time difference of arrival (DL-TDOA), etc.) of a target UE by providing an additional anchor (e.g., using sidelink RTT (SL-RTT)). In scenario 1320, a low-end (e.g., reduced capacity, or “RedCap”) target UE may obtain the assistance of premium UEs to determine its location using, e.g., sidelink positioning and ranging procedures with the premium UEs. Compared to the low-end UE, the premium UEs may have more capabilities, such as more sensors, a faster processor, more memory, more antenna elements, higher transmit power capability, access to additional frequency bands, or any combination thereof. In scenario 1330, a relay UE (e.g., with a known location) participates in the positioning estimation of a remote UE without performing uplink positioning reference signal (PRS) transmission over the Uu interface. Scenario 1340 illustrates the joint positioning of multiple UEs. Specifically, in scenario 1340, two UEs with unknown positions can be jointly located in non-line-of-sight (NLOS) conditions by utilizing constraints from nearby UEs.

FIG. 13B illustrates additional scenarios of interest for sidelink-only or joint Uu and sidelink positioning, according to aspects of the disclosure. In scenario 1350, UEs used for public safety (e.g., by police, firefighters, and/or the like) may perform peer-to-peer (P2P) positioning and ranging for public safety and other uses. For example, in scenario 1350, the public safety UEs may be out of coverage of a network and determine a location or a relative distance and a relative position among the public safety UEs using sidelink positioning techniques. Similarly, scenario 1360 shows multiple UEs that are out of coverage and determine a location or a relative distance and a relative position using sidelink positioning techniques, such as SL-RTT.

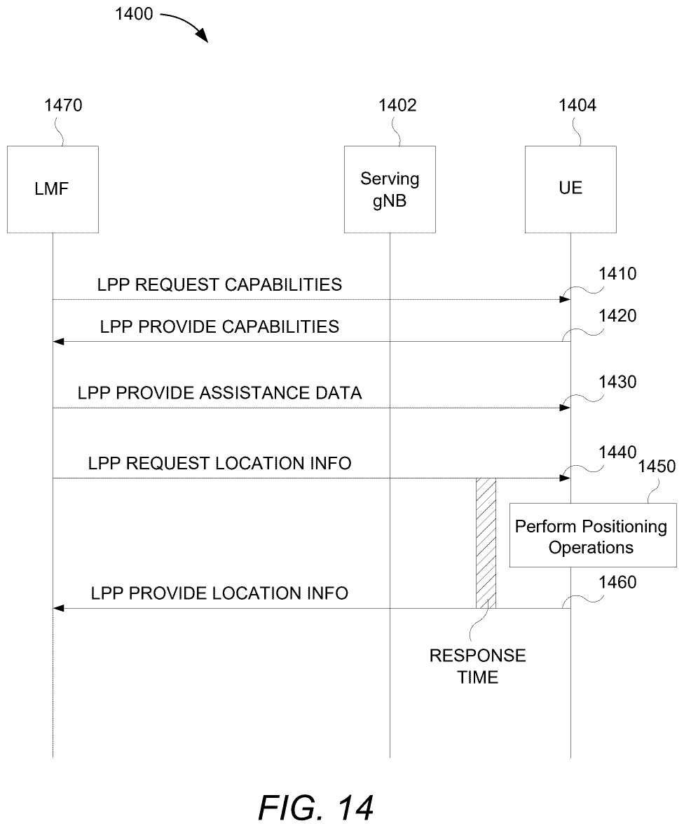

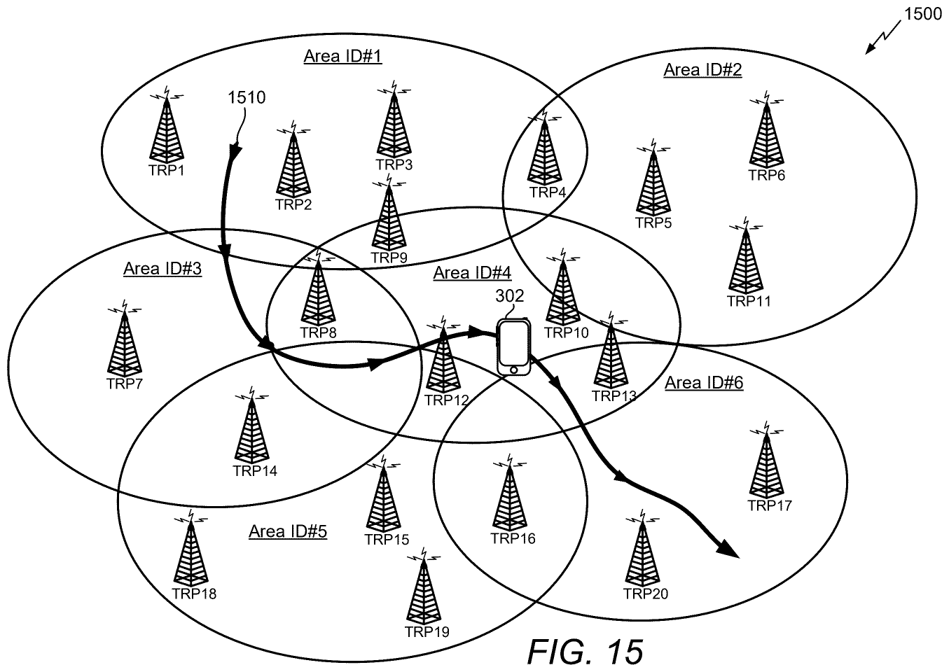

FIG. 14 illustrates an example Long-Term Evolution (LTE) positioning protocol (LPP) procedure 1400 between a UE 1404 and a location server (illustrated as a location management function (LMF) 1470) for performing positioning operations. As illustrated in FIG. 14, positioning of the UE 1404 is supported via an exchange of LPP messages between the UE 1404 and the LMF 1470. The LPP messages may be exchanged between UE 1404 and the LMF 1470 via the UE's 1404 serving base station (illustrated as a serving gNB 1402) and a core network (not shown). The LPP procedure 1400 may be used to position the UE 1404 in order to support various location-related services, such as navigation for UE 1404 (or for the user of UE 1404), or for routing, or for provision of an accurate location to a public safety answering point (PSAP) in association with an emergency call from UE 1404 to a PSAP, or for some other reason. The LPP procedure 1400 may also be referred to as a positioning session, and there may be multiple positioning sessions for different types of positioning methods (e.g., downlink time difference of arrival (DL-TDOA), round-trip-time (RTT), enhanced cell identity (E-CID), etc.).

Initially, the UE 1404 may receive a request for its positioning capabilities from the LMF 1470 at stage 1410 (e.g., an LPP Request Capabilities message). At stage 1420, the UE 1404 provides its positioning capabilities to the LMF 1470 relative to the LPP protocol by sending an LPP Provide Capabilities message to LMF 1470 indicating the position methods and features of these position methods that are supported by the UE 1404 using LPP. The capabilities indicated in the LPP Provide Capabilities message may, in some aspects, indicate the type of positioning the UE 1404 supports (e.g., DL-TDOA, RTT, E-CID, etc.) and may indicate the capabilities of the UE 1404 to support those types of positioning.

Upon reception of the LPP Provide Capabilities message, at stage 1420, the LMF 1470 determines to use a particular type of positioning method (e.g., DL-TDOA, RTT, E-CID, etc.) based on the indicated type(s) of positioning the UE 1404 supports and determines a set of one or more transmission-reception points (TRPs) from which the UE 1404 is to measure downlink positioning reference signals or towards which the UE 1404 is to transmit uplink positioning reference signals. At stage 1430, the LMF 1470 sends an LPP Provide Assistance Data message to the UE 1404 identifying the set of TRPs.

In some implementations, the LPP Provide Assistance Data message at stage 1430 may be sent by the LMF 1470 to the UE 1404 in response to an LPP Request Assistance Data message sent by the UE 1404 to the LMF 1470 (not shown in FIG. 14). An LPP Request Assistance Data message may include an identifier of the UE's 1404 serving TRP and a request for the positioning reference signal (PRS) configuration of neighboring TRPs.

At stage 1440, the LMF 1470 sends a request for location information to the UE 1404. The request may be an LPP Request Location Information message. This message usually includes information elements defining the location information type, desired accuracy of the location estimate, and response time (i.e., desired latency). Note that a low latency requirement allows for a longer response time while a high latency requirement requires a shorter response time. However, a long response time is referred to as high latency and a short response time is referred to as low latency.

Note that in some implementations, the LPP Provide Assistance Data message sent at stage 1430 may be sent after the LPP Request Location Information message at 1440 if, for example, the UE 1404 sends a request for assistance data to LMF 1470 (e.g., in an LPP Request Assistance Data message, not shown in FIG. 14) after receiving the request for location information at stage 1440.

At stage 1450, the UE 1404 utilizes the assistance information received at stage 1430 and any additional data (e.g., a desired location accuracy or a maximum response time) received at stage 1440 to perform positioning operations (e.g., measurements of DL-PRS, transmission of UL-PRS, etc.) for the selected positioning method.

At stage 1460, the UE 1404 may send an LPP Provide Location Information message to the LMF 1470 conveying the results of any measurements that were obtained at stage 1450 (e.g., time of arrival (ToA), reference signal time difference (RSTD), reception-to-transmission (Rx-Tx), etc.) and before or when any maximum response time has expired (e.g., a maximum response time provided by the LMF 1470 at stage 1440). The LPP Provide Location Information message at stage 1460 may also include the time (or times) at which the positioning measurements were obtained and the identity of the TRP(s) from which the positioning measurements were obtained. Note that the time between the request for location information at 1440 and the response at 1460 is the “response time” and indicates the latency of the positioning session.

The LMF 1470 computes an estimated location of the UE 1404 using the appropriate positioning techniques (e.g., DL-TDOA, RTT, E-CID, etc.) based, at least in part, on measurements received in the LPP Provide Location Information message at stage 1460.

In some designs, multiple instances of PRS assistance data (AD) can be supported in LPP. For example, one or more NR-DL-PRS-AssistanceData-r16 elements can be provided in one or more LPP Assistance Data messages. An area ID corresponds to a set of cells on which the UE may use the associated AD (e.g., while camped on/connected on a respective cell among the set of cells). In some designs, the involved cell IDs associated with an area ID may be explicitly listed in LPP along with the assistance data. The list can be provided per instance of assistance data. In some designs, there is no need for the UE to report area ID along with PRS measurement to the LMF if the PRS AD is associated with area ID.

In some designs, the area ID can be broadcasted in the system information (e.g., this has no specification impact if the area ID is defined to be something already broadcasted in the system information). If the UE receives assistance data for a PRS-ID and cell ID combination for which the UE has already stored assistance data, the UE overwrites the stored assistance data. If the UE receives assistance data for a PRS-ID and cell ID combination for which the UE has not stored assistance data, the UE maintains its stored assistance data for other PRS-ID and cell ID combinations. In some designs, the UE may report a UE capability for the number of PRS-ID and cell ID combinations for which the UE can store AD. In some designs (e.g., 3GPP Rel. 17), validity timers are not used for AD.

FIG. 15 illustrates an area ID arrangement 1500, in accordance with aspects of the disclosure. Referring to FIG. 15, the area ID arrangement 1500 includes area IDs #1 through #6. Each of area IDs #1 through #6 is associated with a respective group of wireless nodes (e.g., TRPs), as follows:

TABLE 1

| Area-ID-to-TRP Associations | |
|---|---|
| Area ID # | Associated TRPs |
| #1 | TRPs 1, 2, 3, 4, 9 |
| #2 | TRPs 4, 5, 6, 11 |
| #3 | TRPs 7, 8, 14 |
| #4 | TRPs 8, 9, 10, 12, 13 |
| #5 | TRPs 12, 14, 16, 18, 19 |
| #6 | TRPs 13, 16, 17, 20 |

As noted above, DL-PRS assistance data (with associated validity criteria) can be provided to the UE (before or during an ongoing LPP positioning session), to be then utilized for potential positioning measurements at a future time (e.g. for deferred MT-LR). Pre-configured DL-PRS assistance data may include multiple instances, where each instance is applicable to a different area within the network. Each DL-PRS assistance data instance can be associated with an Area ID. The area ID includes of a list of cells where the UE can be camped on/connected. The applicable Area ID at the UE location is selected based on the cell where the UE is camped on/connected. The instance of the assistance data is valid/selected if the UE is camped on/connected to one of cells indicated within the list of cells in the area ID.

In some designs, the AD to be used for a position estimation session of a UE is determined by a current serving cell of the UE. In other words, the AD associated with the area ID to which the serving cell belongs is used. There is no explicit signaling from LMF to select a specific area ID. However, in a denser cell deployment such as the one depicted in FIG. 15, there will be cases where we might have same physical cell identifier (PCI) is associated with multiple area IDs (e.g., see TRP 4, 8, 9, etc. in FIG. 15). As UE 302 moves through the network as shown at 1510, UE 302 may handoff to such TRPs. As the UE connects/camps on TRPs associated with multiple area IDs, there is currently no mechanism by which UE 302 is capable of selecting the AD to be used for positioning (e.g., each area ID with which the TRP is associated is theoretically available for selection).

Aspects of the disclosure relate to selection of area ID(s) for a position estimation procedure of a UE based on one or more selection parameters, whereby the UE is connected to (e.g., camped on) a serving cell associated with multiple area IDs. Such aspects may provide various technical advantages, such as improving position estimation accuracy, reducing position estimation latency, improving position estimation consistency after a handoff is performed, and so on.

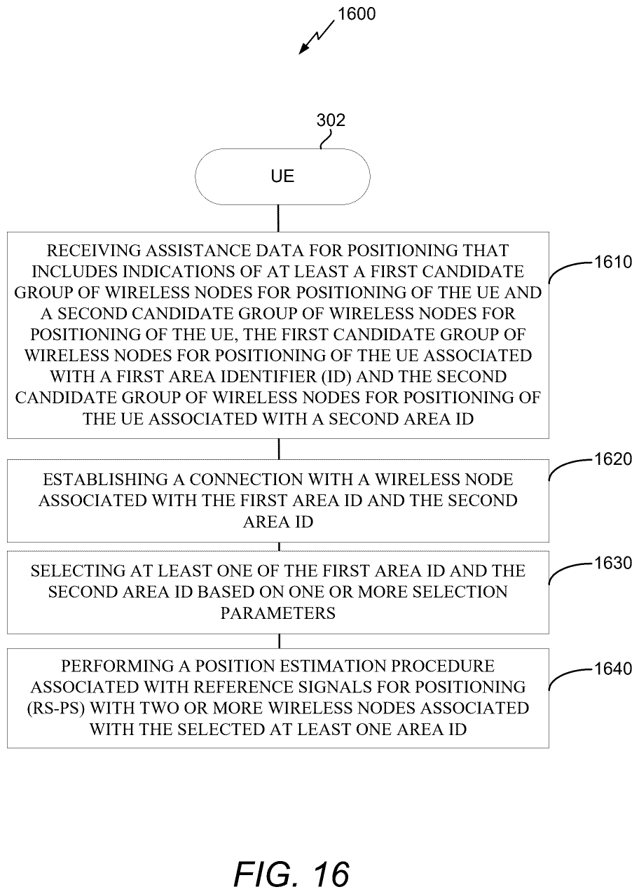

FIG. 16 illustrates an exemplary process 1600 of communications according to an aspect of the disclosure. The process 1600 of FIG. 16 is performed by a UE, such as UE 302.

Referring to FIG. 16, at 1610, UE 302 (e.g., receiver 312 or 322, etc.) receives assistance data for positioning that includes indications of at least a first candidate group of wireless nodes for positioning of the UE and a second candidate group of wireless nodes for positioning of the UE, the first candidate group of wireless nodes for positioning of the UE associated with a first area identifier (ID) and the second candidate group of wireless nodes for positioning of the UE associated with a second area ID.

Referring to FIG. 16, at 1620, UE 302 (e.g., receiver 312 or 322, transmitter 314 or 324, etc.) establishes a connection with a wireless node associated with the first area ID and the second area ID.

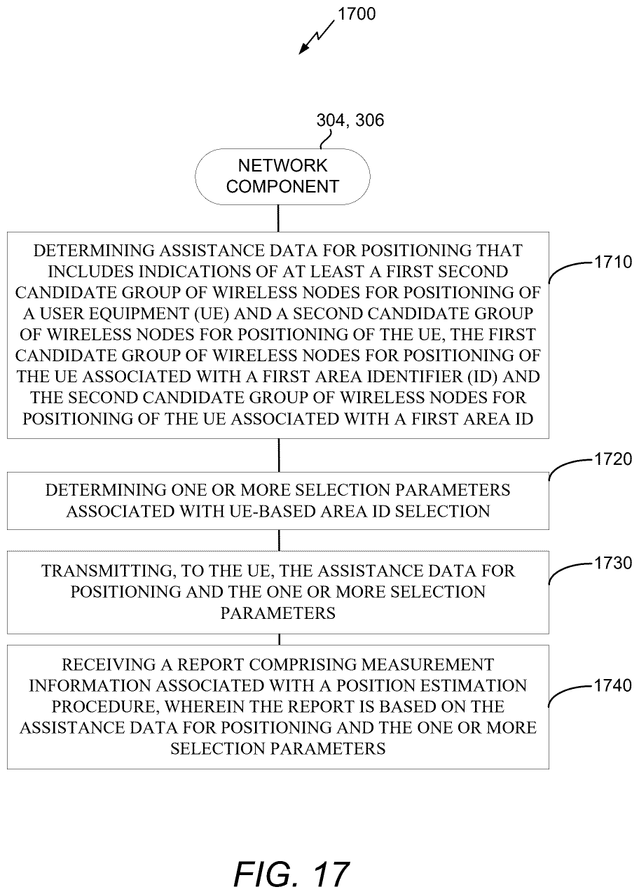

Referring to FIG. 16, at 1630, UE 302 (e.g., processor(s) 332, positioning component 342, etc.) selects at least one of the first area ID and the second area ID based on one or more selection parameters. In some designs, the one or more selection parameters may be received from a network component (e.g., gNB or TRP or LMF, etc.) as described below with respect to FIG. 17. In other designs, the one or more selection parameters may be configured by a different component.

Referring to FIG. 16, at 1640, UE 302 (e.g., processor(s) 332, positioning component 342, receiver 312 or 322, transmitter 314 or 324, etc.) performs a position estimation procedure associated with reference signals for positioning (RS-Ps) with two or more wireless nodes associated with the selected at least one area ID.

FIG. 17 illustrates an exemplary process 1700 of communications according to an aspect of the disclosure. The process 1700 of FIG. 17 is performed by a network component, such as a TRP (e.g., BS 304 or an O-RAN component), network entity 306 such as an LMF integrated with or remote from the TRP, etc.

Referring to FIG. 17, at 1710, the network component (e.g., positioning component 388 or 398, processor(s) 384 or 394, etc.) determines assistance data for positioning that includes indications of at least a first second candidate group of wireless nodes for positioning of a user equipment (UE) and a second candidate group of wireless nodes for positioning of the UE, the first candidate group of wireless nodes for positioning of the UE associated with a first area identifier (ID) and the second candidate group of wireless nodes for positioning of the UE associated with a second area ID.

Referring to FIG. 17, at 1720, the network component (e.g., positioning component 388 or 398, processor(s) 384 or 394, etc.) determines one or more selection parameters associated with UE-based area ID selection.

Referring to FIG. 17, at 1730, the network component (e.g., receiver 352 or 362, network transceiver(s) 380 or 390, etc.) transmits, to the UE, the assistance data for positioning and the one or more selection parameters.

Referring to FIG. 17, at 1740, the network component (e.g., receiver 352 or 362, network transceiver(s) 380 or 390, etc.) receives a report comprising measurement information associated with a position estimation procedure, wherein the report is based on the assistance data for positioning and the one or more selection parameters.

Referring to FIGS. 16-17, in some designs, the selected at least one area ID may include only one of the first area ID and the second area ID. In other designs, the selected at least one area ID comprises both the first area ID and the second area ID. For example, the position estimation procedure may include measurement windows, and the measurement windows may include a first set of measurement windows associated with the first area ID and a second set of measurement windows associated with the second area ID. In a further example, the network component (e.g., LMF/gNB) may request UE to measure different area ID in a different measurement window (e.g., round robin). For example, respective candidate groups of wireless nodes for positioning of the UE associated with at least the first area ID and the second area ID are measured alternately in accordance with a round robin protocol across the measurement windows. For example, UE may measure to area ID other than serving cell (e.g., UE that is capable of having multiple instances of AD “active” simultaneously). In some designs, may define the multiple measurement window during the positioning session. For example, consider a position estimation session with 4 measurement windows, whereby the UE uses serving cell-based area ID for first 3 measurement window and a non-serving cell-based area ID for the last measurement window.

Referring to FIGS. 16-17, in some designs, the one or more selection parameters comprise
a group size configuration parameter (e.g., UE selects a respective area ID configured with a larger candidate group of wireless nodes), or
a positioning reference set (PRS) resource configuration parameter (e.g., UE selects a respective area ID configured with a higher number of configured PRS resources or configured PRS resource sets), or
a group size detection parameter (e.g., UE selects a respective area ID associated with a higher number of detected wireless nodes), or
a PRS detection parameter (e.g., UE selects a respective area ID associated with a higher number of detected PRS resources or detected PRS resource sets), or
a handover parameter, or
a historical measurement parameter (e.g., UE selects area ID(s) based on historical radio resource management (RRM) measurements or historical PRS measurements), or
a signal quality parameter (e.g., select area ID associated with wireless nodes having a higher RSRP or SNR, neighbor cell power parameter, e.g., UE might have good understanding of its detectable neighbor based on previous RRM and/or positioning measurements, so UE may try to sync area ID with a high performing neighbor cell, etc.),
any combination thereof.

For example, as noted above, the UE may select area ID(s) with a higher number of TRP configured, or area ID(s) with a higher number of PRS resource sets configured, or area ID(s) with a higher number of PRS resources configured.

Referring to FIGS. 16-17, as noted above, one or more detection-based parameters (e.g., a group size detection parameter, or a PRS detection parameter, etc.) may be used for area ID selection, in addition to or in lieu of any configuration-based parameter. For example, for the group size detection parameter, respective numbers of detected wireless nodes for the first area ID and the second ID are determined by measuring the first candidate group of wireless nodes and the second candidate group of wireless nodes with a reduced capability (e.g., reduced in terms of bandwidth, repetition, number of symbols, increased comb-size, etc.). In another example, for the PRS detection parameter, respective numbers of detected PRS resources or detected PRS resource sets for the first area ID and the second ID are determined by measuring the first candidate group of wireless nodes and the second candidate group of wireless nodes with a reduced capability (e.g., reduced in terms of bandwidth, repetition, number of symbols, increased comb-size, etc.). In some designs, searching with reduced capability may help for the UE to obtain area ID results quickly and with reduced effort.

Referring to FIGS. 16-17, in some designs, during a handoff between a source wireless node and a target wireless node associated with another area ID, the UE may measure the two or more wireless nodes associated with the selected at least one area ID and two or more wireless nodes associated with the another area ID (e.g., during handover, UE may measure all the PRS resources belong to the AREA ID of serving cell as well as target handover cell), or may switch from the selected at least one area ID to a common area ID that is associated with both the source wireless node and the target wireless node, or any combination thereof.

Referring to FIGS. 16-17, in some designs, UE may transmit a request to the network component to be associated with the selected at least one area ID, and the network component may then configure the positioning estimation procedure based at least in part upon the request. In some designs, the request indicates multiple area IDs with different priorities. For example, referring to FIG. 15, assume TRP12 (serving cell) is in both area ID #4 and area ID #5. UE is configured that area ID #4 is higher priority than area ID5, and therefore, the UE picks as active the AD of Area ID #4

Referring to FIGS. 16-17, in some designs, UE may receive, from the network component, an indication of an association between the first candidate group of wireless nodes configured for the first area ID and the second candidate group of wireless nodes configured for the second area, or priority information associated with the first area ID and the second area ID, or a combination thereof. For example, assume area ID #1 is a neighbor of area ID #2 and area ID #3. For a UE that is currently using area ID #1, area ID #3 may be deemed to have a higher priority than area ID #2 (e.g., note that this prioritization may not be implemented for UEs connected to a different area ID such as area ID #4, etc.). In a further example, the network component (e.g., LMF/gNB) may select the specific area ID for the UE. For example, the network component (e.g., gNB/LMF) may support signaling to change the area ID during the positioning session based on positioning measurement report during the session. In some designs, lower layer scheduling (e.g., L1/L2) to change the area ID (e.g., MAC CE, DL DCI, etc.).

With respect to the indication of an association between the first candidate group of wireless nodes configured for the first area ID and the second candidate group of wireless nodes configured for the second area, in an example, the network component (e.g., LMF) may provide the association between the area IDs

Referring to FIGS. 16-17, with respect to the signal quality parameter, in an example, within the serving cell, UE could be near to the base station and far away from the base station. If UE is near to the gNB, TRP covered by the serving cell PCI-based area ID will be very accurate and useful. If UE is far away from the gNB, TRP covered by the serving cell PCI-based area ID will not be very accurate and useful. In an aspect, serving cell RSRP/SNR-based area ID selection may be implemented. For example, if RSRP/SNR is very good (e.g., above some threshold), UE need to use serving cell PCI based area ID, and if RSRP/SNR is not strong (e.g., below some threshold), UE may use one or multiple area ID along with serving cell PCI-based area ID.

Referring to FIGS. 16-17, with respect to the signal quality parameter, in another example, if neighbor cell power is high compared to serving cell power (e.g., above some threshold differential), UE may select the area ID based on the neighbor cell. For example, this scenario may occur where UE is on cell boundary and handover is not started. In some designs, an additional area ID may be based on the second-best neighbor cell detected, e.g.:

TABLE 2
RSRP-SNR-Based Area ID Selection Examples

| RSRP/SNR | Area ID Selection |
|---|---|
| X > RSRP/SNR | Select Only Serving Cell-Based Area |
| | ID(s) |
| X1 < RSRP/SNR ≤ | Select Serving Cell-Based Area ID(s) and |
| X(X1 < X) | One (1) Neighbor Area ID (e.g., based on |
| | priority, neighbor cell power, etc.) |
| X2 < RSRP/SNR ≤ | Select Serving Cell-Based Area ID(s) and |
| X1 (X2 < X1) | Two (2) Neighbor Area IDs (e.g., based on |
| | priority, neighbor cell power, etc.) |

Referring to FIGS. 16-17, in some designs, the wireless node corresponds to a serving network component of the UE and the RS-Ps comprise downlink positioning reference signal (PRS), uplink PRS, or both.

Referring to FIGS. 16-17, in some designs, the wireless node corresponds to a sidelink UE and the RS-Ps comprise sidelink PRS. For example, if the AD includes sidelink PRS resources, the UE may select the area ID that includes the UE that is also the relay UE. In another example, the UE may select the area ID that includes a higher number of UEs (e.g., group size configuration parameter or group size detection parameter), a higher number of SL PRS resources UEs (e.g., PRS configuration parameter or PRS detection parameter), and so on. In another example, the UE may select the area ID that includes UEs that are closest to the respective UE. In another example, the UE may select the area ID that includes UEs with a highest SINR, RSRP to the respective UE (e.g., signal quality parameter).

Referring to FIGS. 16-17, in some designs a new sidelink (SL) area ID may be defined (e.g., UE receives multiple instances of SL-AD, each one associated with a different SL-AREA-ID. In this case, the UE may select the SL-AD that includes the UE that is also the relay UE. In another example, the UE may select SL-AD that includes a higher number of UEs (e.g., group size configuration parameter or group size detection parameter), a higher number of SL PRS resources UEs (e.g., PRS configuration parameter or PRS detection parameter), and so on. In another example, the UE may select the SL-AD that includes UEs that are closest to the respective UE. In another example, the UE may select the SL-AD that includes UEs with a highest SINR, RSRP to the respective UE (e.g., signal quality parameter). In some designs, UE may report (e.g., to a network component such as LMF) a UE capability indicating a number of SL-AD instances supported by the UE. In some designs, UE may report (e.g., to a network component such as LMF) a UE capability indicating a number of SL-AD instances supported by the UE across SL and Uu (e.g., one total number, or an SL-specific number and Uu-specific number, etc.).

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:
Clause 1. A method of operating a user equipment (UE), comprising: receiving assistance data for positioning that includes indications of at least a first candidate group of wireless nodes for positioning of the UE and a second candidate group of wireless nodes for positioning of the UE, the first candidate group of wireless nodes for positioning of the UE associated with a first area identifier (ID) and the second candidate group of wireless nodes for positioning of the UE associated with a second area ID; establishing a connection with a wireless node associated with the first area ID and the second area ID; selecting at least one of the first area ID and the second area ID based on one or more selection parameters; and performing a position estimation procedure associated with reference signals for positioning (RS-Ps) with two or more wireless nodes associated with the selected at least one area ID.
Clause 2. The method of clause 1, wherein the selected at least one area ID comprises only one of the first area ID and the second area ID.
Clause 3. The method of any of clauses 1 to 2, wherein the selected at least one area ID comprises both the first area ID and the second area ID.
Clause 4. The method of clause 3, wherein the position estimation procedure comprises measurement windows, the measurement windows comprising a first set of measurement windows associated with the first area ID and a second set of measurement windows associated with the second area ID.
Clause 5. The method of clause 4, wherein respective candidate groups of wireless nodes for positioning of the UE associated with at least the first area ID and the second area ID are measured alternately in accordance with a round robin protocol across the measurement windows.
Clause 6. The method of any of clauses 1 to 5, wherein the one or more selection parameters comprise: a group size configuration parameter, or a positioning reference set (PRS) resource configuration parameter, or a group size detection parameter, or a PRS detection parameter, or a handover parameter, or a historical measurement parameter, or a signal quality parameter, any combination thereof.
Clause 7. The method of clause 6, wherein the selecting selects a respective area ID configured with a larger candidate group of wireless nodes.
Clause 8. The method of any of clauses 6 to 7, wherein the selecting selects a respective area ID configured with a higher number of configured PRS resources or configured PRS resource sets.
Clause 9. The method of any of clauses 6 to 8, wherein the selecting selects a respective area ID associated with a higher number of detected wireless nodes.
Clause 10. The method of clause 9, wherein respective numbers of detected wireless nodes for the first area ID and the second ID are determined by measuring the first candidate group of wireless nodes and the second candidate group of wireless nodes with a reduced capability.
Clause 11. The method of any of clauses 6 to 10, wherein the selecting selects a respective area ID associated with a higher number of detected PRS resources or detected PRS resource sets.
Clause 12. The method of clause 11, wherein respective numbers of detected PRS resources or detected PRS resource sets for the first area ID and the second ID are determined by measuring the first candidate group of wireless nodes and the second candidate group of wireless nodes with a reduced capability.
Clause 13. The method of any of clauses 6 to 12, wherein, during a handoff between a source wireless node and a target wireless node associated with another area ID, the UE: measures the two or more wireless nodes associated with the selected at least one area ID and two or more wireless nodes associated with the another area ID, or switches from the selected at least one area ID to a common area ID that is associated with both the source wireless node and the target wireless node, or any combination thereof.
Clause 14. The method of any of clauses 6 to 13, wherein the selecting is based on historical radio resource management (RRM) measurements or historical PRS measurements.
Clause 15. The method of any of clauses 6 to 14, wherein the one or more selection parameters comprise the signal quality parameter.
Clause 16. The method of any of clauses 1 to 15, further comprising: transmitting a request to be associated with the selected at least one area ID, wherein the positioning estimation procedure is configured based at least in part upon the request.
Clause 17. The method of clause 16, wherein the request indicates multiple area IDs with different priorities.
Clause 18. The method of any of clauses 1 to 17, further comprising: transmitting a report comprising measurement information associated with the position estimation procedure; and receiving, in response to the report, a request to switch to one or more different area IDs for a remainder of the position estimation procedure or to alternate between two or more area IDs.
Clause 19. The method of any of clauses 1 to 18, further comprising: receiving an indication of an association between the first candidate group of wireless nodes configured for the first area ID and the second candidate group of wireless nodes configured for the second area, or receiving priority information associated with the first area ID and the second area ID, or a combination thereof.
Clause 20. The method of any of clauses 1 to 19, wherein the wireless node corresponds to a serving network component of the UE and the RS-Ps comprise downlink positioning reference signal (PRS), uplink PRS, or both, or wherein the wireless node corresponds to a sidelink UE and the RS-Ps comprise sidelink PRS.
Clause 21. A method of operating a network component, comprising: determining assistance data for positioning that includes indications of at least a first second candidate group of wireless nodes for positioning of a user equipment (UE) and a second candidate group of wireless nodes for positioning of the UE, the first candidate group of wireless nodes for positioning of the UE associated with a first area identifier (ID) and the second candidate group of wireless nodes for positioning of the UE associated with a second area ID; determining one or more selection parameters associated with UE-based area ID selection; transmitting, to the UE, the assistance data for positioning and the one or more selection parameters; and receiving a report comprising measurement information associated with a position estimation procedure, wherein the report is based on the assistance data for positioning and the one or more selection parameters.
Clause 22. The method of clause 21, wherein the one or more selection parameters comprise: a group size configuration parameter, or a positioning reference set (PRS) resource configuration parameter, or a group size detection parameter, or a PRS detection parameter, or a handover parameter, or a historical measurement parameter, or a signal quality parameter, any combination thereof.
Clause 23. The method of any of clauses 21 to 22, wherein the one or more selection parameters comprise: wherein the position estimation procedure comprises measurement windows, and wherein the one or more selection parameters comprise a designation of a first set of measurement windows associated with the first area ID and a second set of measurement windows associated with the second area ID.
Clause 24. The method of any of clauses 21 to 23, wherein the one or more selection parameters comprise: an indication of an association between the first candidate group of wireless nodes configured for the first area ID and the second candidate group of wireless nodes configured for the second area, or priority information associated with the first area ID and the second area ID, or a request for the position estimation procedure to be associated with a designated at least one area ID, or a combination thereof.
Clause 25. The method of clause 24, transmitting, in response to the report, a request to switch to one or more different area IDs for a remainder of the position estimation procedure or to alternate between two or more area IDs.
Clause 26. The method of any of clauses 21 to 25, wherein the report is associated with only one of the first area ID and the second area ID.
Clause 27. The method of any of clauses 21 to 26, wherein the report is associated with both the first area ID and the second area ID.
Clause 28. The method of any of clauses 21 to 27, wherein the wireless node corresponds to a serving network component of the UE and the RS-Ps comprise downlink positioning reference signal (PRS), uplink PRS, or both, or wherein the wireless node corresponds to a sidelink UE and the RS-Ps comprise sidelink PRS.
Clause 29. A user equipment (UE), comprising: a memory; at least one transceiver; and at least one processor communicatively coupled to the memory and the at least one transceiver, the at least one processor configured to: receive, via the at least one transceiver, assistance data for positioning that includes indications of at least a first candidate group of wireless nodes for positioning of the UE and a second candidate group of wireless nodes for positioning of the UE, the first candidate group of wireless nodes for positioning of the UE associated with a first area identifier (ID) and the second candidate group of wireless nodes for positioning of the UE associated with a second area ID; establish a connection with a wireless node associated with the first area ID and the second area ID; select at least one of the first area ID and the second area ID based on one or more selection parameters; and perform a position estimation procedure associated with reference signals for positioning (RS-Ps) with two or more wireless nodes associated with the selected at least one area ID.
Clause 30. The UE of clause 29, wherein the selected at least one area ID comprises only one of the first area ID and the second area ID.
Clause 31. The UE of any of clauses 29 to 30, wherein the selected at least one area ID comprises both the first area ID and the second area ID.
Clause 32. The UE of clause 31, wherein the position estimation procedure comprises measurement windows, the measurement windows comprising a first set of measurement windows associated with the first area ID and a second set of measurement windows associated with the second area ID.
Clause 33. The UE of clause 32, wherein respective candidate groups of wireless nodes for positioning of the UE associated with at least the first area ID and the second area ID are measured alternately in accordance with a round robin protocol across the measurement windows.
Clause 34. The UE of any of clauses 29 to 33, wherein the one or more selection parameters comprise: a group size configuration parameter, or a positioning reference set (PRS) resource configuration parameter, or a group size detection parameter, or a PRS detection parameter, or a handover parameter, or a historical measurement parameter, or a signal quality parameter, any combination thereof.
Clause 35. The UE of clause 34, wherein the selecting selects a respective area ID configured with a larger candidate group of wireless nodes.
Clause 36. The UE of any of clauses 34 to 35, wherein the selecting selects a respective area ID configured with a higher number of configured PRS resources or configured PRS resource sets.
Clause 37. The UE of any of clauses 34 to 36, wherein the selecting selects a respective area ID associated with a higher number of detected wireless nodes.
Clause 38. The UE of clause 37, wherein respective numbers of detected wireless nodes for the first area ID and the second ID are determined by measuring the first candidate group of wireless nodes and the second candidate group of wireless nodes with a reduced capability.
Clause 39. The UE of any of clauses 34 to 38, wherein the selecting selects a respective area ID associated with a higher number of detected PRS resources or detected PRS resource sets.
Clause 40. The UE of clause 39, wherein respective numbers of detected PRS resources or detected PRS resource sets for the first area ID and the second ID are determined by measuring the first candidate group of wireless nodes and the second candidate group of wireless nodes with a reduced capability.
Clause 41. The UE of any of clauses 34 to 40, wherein, during a handoff between a source wireless node and a target wireless node associated with another area ID, the UE: measures the two or more wireless nodes associated with the selected at least one area ID and two or more wireless nodes associated with the another area ID, or switches from the selected at least one area ID to a common area ID that is associated with both the source wireless node and the target wireless node, or any combination thereof.
Clause 42. The UE of any of clauses 34 to 41, wherein the selecting is based on historical radio resource management (RRM) measurements or historical PRS measurements.
Clause 43. The UE of any of clauses 34 to 42, wherein the one or more selection parameters comprise the signal quality parameter.
Clause 44. The UE of any of clauses 29 to 43, wherein the at least one processor is further configured to: transmit, via the at least one transceiver, a request to be associated with the selected at least one area ID, wherein the positioning estimation procedure is configured based at least in part upon the request.
Clause 45. The UE of clause 44, wherein the request indicates multiple area IDs with different priorities.
Clause 46. The UE of any of clauses 29 to 45, wherein the at least one processor is further configured to: transmit, via the at least one transceiver, a report comprising measurement information associated with the position estimation procedure; and receive, via the at least one transceiver, in response to the report, a request to switch to one or more different area IDs for a remainder of the position estimation procedure or to alternate between two or more area IDs.
Clause 47. The UE of any of clauses 29 to 46, wherein the at least one processor is further configured to: receive, via the at least one transceiver, an indication of an association between the first candidate group of wireless nodes configured for the first area ID and the second candidate group of wireless nodes configured for the second area, or receive, via the at least one transceiver, priority information associated with the first area ID and the second area ID, or a combination thereof.
Clause 48. The UE of any of clauses 29 to 47, wherein the wireless node corresponds to a serving network component of the UE and the RS-Ps comprise downlink positioning reference signal (PRS), uplink PRS, or both, or wherein the wireless node corresponds to a sidelink UE and the RS-Ps comprise sidelink PRS.
Clause 49. A network component, comprising: a memory; at least one transceiver; and at least one processor communicatively coupled to the memory and the at least one transceiver, the at least one processor configured to: determine assistance data for positioning that includes indications of at least a first second candidate group of wireless nodes for positioning of a user equipment (UE) and a second candidate group of wireless nodes for positioning of the UE, the first candidate group of wireless nodes for positioning of the UE associated with a first area identifier (ID) and the second candidate group of wireless nodes for positioning of the UE associated with a second area ID; determine one or more selection parameters associated with UE-based area ID selection; transmit, via the at least one transceiver, to the UE, the assistance data for positioning and the one or more selection parameters; and receive, via the at least one transceiver, a report comprising measurement information associated with a position estimation procedure, wherein the report is based on the assistance data for positioning and the one or more selection parameters.
Clause 50. The network component of clause 49, wherein the one or more selection parameters comprise: a group size configuration parameter, or a positioning reference set (PRS) resource configuration parameter, or a group size detection parameter, or a PRS detection parameter, or a handover parameter, or a historical measurement parameter, or a signal quality parameter, any combination thereof.
Clause 51. The network component of any of clauses 49 to 50, wherein the one or more selection parameters comprise: wherein the position estimation procedure comprises measurement windows, and wherein the one or more selection parameters comprise a designation of a first set of measurement windows associated with the first area ID and a second set of measurement windows associated with the second area ID.
Clause 52. The network component of any of clauses 49 to 51, wherein the one or more selection parameters comprise: an indication of an association between the first candidate group of wireless nodes configured for the first area ID and the second candidate group of wireless nodes configured for the second area, or priority information associated with the first area ID and the second area ID, or a request for the position estimation procedure to be associated with a designated at least one area ID, or a combination thereof.
Clause 53. The network component of clause 52, transmit, via the at least one transceiver, in response to the report, a request to switch to one or more different area IDs for a remainder of the position estimation procedure or to alternate between two or more area IDs.
Clause 54. The network component of any of clauses 49 to 53, wherein the report is associated with only one of the first area ID and the second area ID.
Clause 55. The network component of any of clauses 49 to 54, wherein the report is associated with both the first area ID and the second area ID.
Clause 56. The network component of any of clauses 49 to 55, wherein the wireless node corresponds to a serving network component of the UE and the RS-Ps comprise downlink positioning reference signal (PRS), uplink PRS, or both, or wherein the wireless node corresponds to a sidelink UE and the RS-Ps comprise sidelink PRS.
Clause 57. A user equipment (UE), comprising: means for receiving assistance data for positioning that includes indications of at least a first candidate group of wireless nodes for positioning of the UE and a second candidate group of wireless nodes for positioning of the UE, the first candidate group of wireless nodes for positioning of the UE associated with a first area identifier (ID) and the second candidate group of wireless nodes for positioning of the UE associated with a second area ID; means for establishing a connection with a wireless node associated with the first area ID and the second area ID; means for selecting at least one of the first area ID and the second area ID based on one or more selection parameters; and means for performing a position estimation procedure associated with reference signals for positioning (RS-Ps) with two or more wireless nodes associated with the selected at least one area ID.
Clause 58. The UE of clause 57, wherein the selected at least one area ID comprises only one of the first area ID and the second area ID.
Clause 59. The UE of any of clauses 57 to 58, wherein the selected at least one area ID comprises both the first area ID and the second area ID.
Clause 60. The UE of clause 59, wherein the position estimation procedure comprises measurement windows, the measurement windows comprising a first set of measurement windows associated with the first area ID and a second set of measurement windows associated with the second area ID.
Clause 61. The UE of clause 60, wherein respective candidate groups of wireless nodes for positioning of the UE associated with at least the first area ID and the second area ID are measured alternately in accordance with a round robin protocol across the measurement windows.
Clause 62. The UE of any of clauses 57 to 61, wherein the one or more selection parameters comprise: a group size configuration parameter, or a positioning reference set (PRS) resource configuration parameter, or a group size detection parameter, or a PRS detection parameter, or a handover parameter, or a historical measurement parameter, or a signal quality parameter, any combination thereof.
Clause 63. The UE of clause 62, wherein the selecting selects a respective area ID configured with a larger candidate group of wireless nodes.
Clause 64. The UE of any of clauses 62 to 63, wherein the selecting selects a respective area ID configured with a higher number of configured PRS resources or configured PRS resource sets.
Clause 65. The UE of any of clauses 62 to 64, wherein the selecting selects a respective area ID associated with a higher number of detected wireless nodes.
Clause 66. The UE of clause 65, wherein respective numbers of detected wireless nodes for the first area ID and the second ID are determined by measuring the first candidate group of wireless nodes and the second candidate group of wireless nodes with a reduced capability.
Clause 67. The UE of any of clauses 62 to 66, wherein the selecting selects a respective area ID associated with a higher number of detected PRS resources or detected PRS resource sets.
Clause 68. The UE of clause 67, wherein respective numbers of detected PRS resources or detected PRS resource sets for the first area ID and the second ID are determined by measuring the first candidate group of wireless nodes and the second candidate group of wireless nodes with a reduced capability.
Clause 69. The UE of any of clauses 62 to 68, wherein, during a handoff between a source wireless node and a target wireless node associated with another area ID, the UE: measures the two or more wireless nodes associated with the selected at least one area ID and two or more wireless nodes associated with the another area ID, or switches from the selected at least one area ID to a common area ID that is associated with both the source wireless node and the target wireless node, or any combination thereof.
Clause 70. The UE of any of clauses 62 to 69, wherein the selecting is based on historical radio resource management (RRM) measurements or historical PRS measurements.
Clause 71. The UE of any of clauses 62 to 70, wherein the one or more selection parameters comprise the signal quality parameter.
Clause 72. The UE of any of clauses 57 to 71, further comprising: means for transmitting a request to be associated with the selected at least one area ID, wherein the positioning estimation procedure is configured based at least in part upon the request.
Clause 73. The UE of clause 72, wherein the request indicates multiple area IDs with different priorities.
Clause 74. The UE of any of clauses 57 to 73, further comprising: means for transmitting a report comprising measurement information associated with the position estimation procedure; and means for receiving, in response to the report, a request to switch to one or more different area IDs for a remainder of the position estimation procedure or to alternate between two or more area IDs.
Clause 75. The UE of any of clauses 57 to 74, further comprising: means for receiving an indication of an association between the first candidate group of wireless nodes configured for the first area ID and the second candidate group of wireless nodes configured for the second area, or means for receiving priority information associated with the first area ID and the second area ID, or a combination thereof.
Clause 76. The UE of any of clauses 57 to 75, wherein the wireless node corresponds to a serving network component of the UE and the RS-Ps comprise downlink positioning reference signal (PRS), uplink PRS, or both, or wherein the wireless node corresponds to a sidelink UE and the RS-Ps comprise sidelink PRS.
Clause 77. A network component, comprising: means for determining assistance data for positioning that includes indications of at least a first second candidate group of wireless nodes for positioning of a user equipment (UE) and a second candidate group of wireless nodes for positioning of the UE, the first candidate group of wireless nodes for positioning of the UE associated with a first area identifier (ID) and the second candidate group of wireless nodes for positioning of the UE associated with a second area ID; means for determining one or more selection parameters associated with UE-based area ID selection; means for transmitting, to the UE, the assistance data for positioning and the one or more selection parameters; and means for receiving a report comprising measurement information associated with a position estimation procedure, wherein the report is based on the assistance data for positioning and the one or more selection parameters.
Clause 78. The network component of clause 77, wherein the one or more selection parameters comprise: a group size configuration parameter, or a positioning reference set (PRS) resource configuration parameter, or a group size detection parameter, or a PRS detection parameter, or a handover parameter, or a historical measurement parameter, or a signal quality parameter, any combination thereof.
Clause 79. The network component of any of clauses 77 to 78, wherein the one or more selection parameters comprise: wherein the position estimation procedure comprises measurement windows, and wherein the one or more selection parameters comprise a designation of a first set of measurement windows associated with the first area ID and a second set of measurement windows associated with the second area ID.
Clause 80. The network component of any of clauses 77 to 79, wherein the one or more selection parameters comprise: an indication of an association between the first candidate group of wireless nodes configured for the first area ID and the second candidate group of wireless nodes configured for the second area, or priority information associated with the first area ID and the second area ID, or a request for the position estimation procedure to be associated with a designated at least one area ID, or a combination thereof.
Clause 81. The network component of clause 80, means for transmitting, in response to the report, a request to switch to one or more different area IDs for a remainder of the position estimation procedure or to alternate between two or more area IDs.
Clause 82. The network component of any of clauses 77 to 81, wherein the report is associated with only one of the first area ID and the second area ID.
Clause 83. The network component of any of clauses 77 to 82, wherein the report is associated with both the first area ID and the second area ID.
Clause 84. The network component of any of clauses 77 to 83, wherein the wireless node corresponds to a serving network component of the UE and the RS-Ps comprise downlink positioning reference signal (PRS), uplink PRS, or both, or wherein the wireless node corresponds to a sidelink UE and the RS-Ps comprise sidelink PRS.
Clause 85. A non-transitory computer-readable medium storing computer-executable instructions that, when executed by a user equipment (UE), cause the UE to: receive assistance data for positioning that includes indications of at least a first candidate group of wireless nodes for positioning of the UE and a second candidate group of wireless nodes for positioning of the UE, the first candidate group of wireless nodes for positioning of the UE associated with a first area identifier (ID) and the second candidate group of wireless nodes for positioning of the UE associated with a second area ID; establish a connection with a wireless node associated with the first area ID and the second area ID; select at least one of the first area ID and the second area ID based on one or more selection parameters; and perform a position estimation procedure associated with reference signals for positioning (RS-Ps) with two or more wireless nodes associated with the selected at least one area ID.
Clause 86. The non-transitory computer-readable medium of clause 85, wherein the selected at least one area ID comprises only one of the first area ID and the second area ID.
Clause 87. The non-transitory computer-readable medium of any of clauses 85 to 86, wherein the selected at least one area ID comprises both the first area ID and the second area ID.
Clause 88. The non-transitory computer-readable medium of clause 87, wherein the position estimation procedure comprises measurement windows, the measurement windows comprising a first set of measurement windows associated with the first area ID and a second set of measurement windows associated with the second area ID.
Clause 89. The non-transitory computer-readable medium of clause 88, wherein respective candidate groups of wireless nodes for positioning of the UE associated with at least the first area ID and the second area ID are measured alternately in accordance with a round robin protocol across the measurement windows.
Clause 90. The non-transitory computer-readable medium of any of clauses 85 to 89, wherein the one or more selection parameters comprise: a group size configuration parameter, or a positioning reference set (PRS) resource configuration parameter, or a group size detection parameter, or a PRS detection parameter, or a handover parameter, or a historical measurement parameter, or a signal quality parameter, any combination thereof.
Clause 91. The non-transitory computer-readable medium of clause 90, wherein the selecting selects a respective area ID configured with a larger candidate group of wireless nodes.
Clause 92. The non-transitory computer-readable medium of any of clauses 90 to 91, wherein the selecting selects a respective area ID configured with a higher number of configured PRS resources or configured PRS resource sets.
Clause 93. The non-transitory computer-readable medium of any of clauses 90 to 92, wherein the selecting selects a respective area ID associated with a higher number of detected wireless nodes.
Clause 94. The non-transitory computer-readable medium of clause 93, wherein respective numbers of detected wireless nodes for the first area ID and the second ID are determined by measuring the first candidate group of wireless nodes and the second candidate group of wireless nodes with a reduced capability.
Clause 95. The non-transitory computer-readable medium of any of clauses 90 to 94, wherein the selecting selects a respective area ID associated with a higher number of detected PRS resources or detected PRS resource sets.
Clause 96. The non-transitory computer-readable medium of clause 95, wherein respective numbers of detected PRS resources or detected PRS resource sets for the first area ID and the second ID are determined by measuring the first candidate group of wireless nodes and the second candidate group of wireless nodes with a reduced capability.
Clause 97. The non-transitory computer-readable medium of any of clauses 90 to 96, wherein, during a handoff between a source wireless node and a target wireless node associated with another area ID, the UE: measures the two or more wireless nodes associated with the selected at least one area ID and two or more wireless nodes associated with the another area ID, or switches from the selected at least one area ID to a common area ID that is associated with both the source wireless node and the target wireless node, or any combination thereof.
Clause 98. The non-transitory computer-readable medium of any of clauses 90 to 97, wherein the selecting is based on historical radio resource management (RRM) measurements or historical PRS measurements.
Clause 99. The non-transitory computer-readable medium of any of clauses 90 to 98, wherein the one or more selection parameters comprise the signal quality parameter.
Clause 100. The non-transitory computer-readable medium of any of clauses 85 to 99, further comprising computer-executable instructions that, when executed by the UE, cause the UE to: transmit a request to be associated with the selected at least one area ID, wherein the positioning estimation procedure is configured based at least in part upon the request.
Clause 101. The non-transitory computer-readable medium of clause 100, wherein the request indicates multiple area IDs with different priorities.
Clause 102. The non-transitory computer-readable medium of any of clauses 85 to 101, further comprising computer-executable instructions that, when executed by the UE, cause the UE to: transmit a report comprising measurement information associated with the position estimation procedure; and receive, in response to the report, a request to switch to one or more different area IDs for a remainder of the position estimation procedure or to alternate between two or more area IDs.
Clause 103. The non-transitory computer-readable medium of any of clauses 85 to 102, further comprising computer-executable instructions that, when executed by the UE, cause the UE to: receive an indication of an association between the first candidate group of wireless nodes configured for the first area ID and the second candidate group of wireless nodes configured for the second area, or receive priority information associated with the first area ID and the second area ID, or a combination thereof.
Clause 104. The non-transitory computer-readable medium of any of clauses 85 to 103, wherein the wireless node corresponds to a serving network component of the UE and the RS-Ps comprise downlink positioning reference signal (PRS), uplink PRS, or both, or wherein the wireless node corresponds to a sidelink UE and the RS-Ps comprise sidelink PRS.
Clause 105. A non-transitory computer-readable medium storing computer-executable instructions that, when executed by a network component, cause the network component to: determine assistance data for positioning that includes indications of at least a first second candidate group of wireless nodes for positioning of a user equipment (UE) and a second candidate group of wireless nodes for positioning of the UE, the first candidate group of wireless nodes for positioning of the UE associated with a first area identifier (ID) and the second candidate group of wireless nodes for positioning of the UE associated with a second area ID; determine one or more selection parameters associated with UE-based area ID selection; transmit, to the UE, the assistance data for positioning and the one or more selection parameters; and receive a report comprising measurement information associated with a position estimation procedure, wherein the report is based on the assistance data for positioning and the one or more selection parameters.
Clause 106. The non-transitory computer-readable medium of clause 105, wherein the one or more selection parameters comprise: a group size configuration parameter, or a positioning reference set (PRS) resource configuration parameter, or a group size detection parameter, or a PRS detection parameter, or a handover parameter, or a historical measurement parameter, or a signal quality parameter, any combination thereof.
Clause 107. The non-transitory computer-readable medium of any of clauses 105 to 106, wherein the one or more selection parameters comprise: wherein the position estimation procedure comprises measurement windows, and wherein the one or more selection parameters comprise a designation of a first set of measurement windows associated with the first area ID and a second set of measurement windows associated with the second area ID.
Clause 108. The non-transitory computer-readable medium of any of clauses 105 to 107, wherein the one or more selection parameters comprise: an indication of an association between the first candidate group of wireless nodes configured for the first area ID and the second candidate group of wireless nodes configured for the second area, or priority information associated with the first area ID and the second area ID, or a request for the position estimation procedure to be associated with a designated at least one area ID, or a combination thereof.
Clause 109. The non-transitory computer-readable medium of clause 108, transmit, in response to the report, a request to switch to one or more different area IDs for a remainder of the position estimation procedure or to alternate between two or more area IDs.
Clause 110. The non-transitory computer-readable medium of any of clauses 105 to 109, wherein the report is associated with only one of the first area ID and the second area ID.
Clause 111. The non-transitory computer-readable medium of any of clauses 105 to 110, wherein the report is associated with both the first area ID and the second area ID.
Clause 112. The non-transitory computer-readable medium of any of clauses 105 to 111, wherein the wireless node corresponds to a serving network component of the UE and the RS-Ps comprise downlink positioning reference signal (PRS), uplink PRS, or both, or wherein the wireless node corresponds to a sidelink UE and the RS-Ps comprise sidelink PRS.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of operating a user equipment (UE), comprising:
receiving assistance data for positioning that includes indications of at least a first candidate group of wireless nodes for positioning of the UE and a second candidate group of wireless nodes for positioning of the UE, the first candidate group of wireless nodes for positioning of the UE associated with a first area identifier (ID) and the second candidate group of wireless nodes for positioning of the UE associated with a second area ID;
establishing a connection with a wireless node associated with the first area ID and the second area ID;
selecting at least one of the first area ID and the second area ID based on one or more selection parameters; and
performing a position estimation procedure associated with reference signals for positioning (RS-Ps) with two or more wireless nodes associated with the selected at least one area ID.

2. The method of claim 1, wherein the selected at least one area ID comprises only one of the first area ID and the second area ID.

3. The method of claim 1, wherein the selected at least one area ID comprises both the first area ID and the second area ID.

4. The method of claim 3, wherein the position estimation procedure comprises measurement windows, the measurement windows comprising a first set of measurement windows associated with the first area ID and a second set of measurement windows associated with the second area ID.

5. The method of claim 4, wherein respective candidate groups of wireless nodes for positioning of the UE associated with at least the first area ID and the second area ID are measured alternately in accordance with a round robin protocol across the measurement windows.

6. The method of claim 1, wherein the one or more selection parameters comprise:
a group size configuration parameter, or
a positioning reference set (PRS) resource configuration parameter, or
a group size detection parameter, or
a PRS detection parameter, or
a handover parameter, or
a historical measurement parameter, or
a signal quality parameter,
any combination thereof.

7. The method of claim 6, wherein the selecting selects a respective area ID configured with a larger candidate group of wireless nodes.

8. The method of claim 6, wherein the selecting selects a respective area ID configured with a higher number of configured PRS resources or configured PRS resource sets.

9. The method of claim 6, wherein the selecting selects a respective area ID associated with a higher number of detected wireless nodes.

10. The method of claim 9, wherein respective numbers of detected wireless nodes for the first area ID and the second ID are determined by measuring the first candidate group of wireless nodes and the second candidate group of wireless nodes with a reduced capability.

11. The method of claim 6, wherein the selecting selects a respective area ID associated with a higher number of detected PRS resources or detected PRS resource sets.

12. The method of claim 11, wherein respective numbers of detected PRS resources or detected PRS resource sets for the first area ID and the second ID are determined by measuring the first candidate group of wireless nodes and the second candidate group of wireless nodes with a reduced capability.

13. The method of claim 6, wherein, during a handoff between a source wireless node and a target wireless node associated with another area ID, the UE:
measures the two or more wireless nodes associated with the selected at least one area ID and two or more wireless nodes associated with the another area ID, or
switches from the selected at least one area ID to a common area ID that is associated with both the source wireless node and the target wireless node, or
any combination thereof.

14. The method of claim 6, wherein the selecting is based on historical radio resource management (RRM) measurements or historical PRS measurements.

15. The method of claim 6, wherein the one or more selection parameters comprise the signal quality parameter.

16. The method of claim 1, further comprising:
transmitting a request to be associated with the selected at least one area ID,
wherein the positioning estimation procedure is configured based at least in part upon the request.

17. The method of claim 16, wherein the request indicates multiple area IDs with different priorities.

18. The method of claim 1, further comprising:
transmitting a report comprising measurement information associated with the position estimation procedure; and
receiving, in response to the report, a request to switch to one or more different area IDs for a remainder of the position estimation procedure or to alternate between two or more area IDs.

19. The method of claim 1, further comprising:
receiving an indication of an association between the first candidate group of wireless nodes configured for the first area ID and the second candidate group of wireless nodes configured for the second area, or
receiving priority information associated with the first area ID and the second area ID, or
a combination thereof.

20. The method of claim 1,
wherein the wireless node corresponds to a serving network component of the UE and the RS-Ps comprise downlink positioning reference signal (PRS), uplink PRS, or both, or
wherein the wireless node corresponds to a sidelink UE and the RS-Ps comprise sidelink PRS.

21. A method of operating a network component, comprising:
determining assistance data for positioning that includes indications of at least a first second candidate group of wireless nodes for positioning of a user equipment (UE) and a second candidate group of wireless nodes for positioning of the UE, the first candidate group of wireless nodes for positioning of the UE associated with a first area identifier (ID) and the second candidate group of wireless nodes for positioning of the UE associated with a second area ID;
determining one or more selection parameters associated with UE-based area ID selection;
transmitting, to the UE, the assistance data for positioning and the one or more selection parameters; and
receiving a report comprising measurement information associated with a position estimation procedure, wherein the report is based on the assistance data for positioning and the one or more selection parameters.

22. The method of claim 21, wherein the one or more selection parameters comprise:
a group size configuration parameter, or
a positioning reference set (PRS) resource configuration parameter, or
a group size detection parameter, or
a PRS detection parameter, or
a handover parameter, or
a historical measurement parameter, or
a signal quality parameter,
any combination thereof.

23. The method of claim 21, wherein the one or more selection parameters comprise:
wherein the position estimation procedure comprises measurement windows, and
wherein the one or more selection parameters comprise a designation of a first set of measurement windows associated with the first area ID and a second set of measurement windows associated with the second area ID.

24. The method of claim 21, wherein the one or more selection parameters comprise:
an indication of an association between the first candidate group of wireless nodes configured for the first area ID and the second candidate group of wireless nodes configured for the second area, or
priority information associated with the first area ID and the second area ID, or
a request for the position estimation procedure to be associated with a designated at least one area ID, or
a combination thereof.

25. The method of claim 24,
transmitting, in response to the report, a request to switch to one or more different area IDs for a remainder of the position estimation procedure or to alternate between two or more area IDs.

26. The method of claim 21, wherein the report is associated with only one of the first area ID and the second area ID.

27. The method of claim 21, wherein the report is associated with both the first area ID and the second area ID.

28. The method of claim 21,
wherein the wireless node corresponds to a serving network component of the UE and the RS-Ps comprise downlink positioning reference signal (PRS), uplink PRS, or both, or
wherein the wireless node corresponds to a sidelink UE and the RS-Ps comprise sidelink PRS.

29. A user equipment (UE), comprising:
a memory;
at least one transceiver; and
at least one processor communicatively coupled to the memory and the at least one transceiver, the at least one processor configured to:
receive, via the at least one transceiver, assistance data for positioning that includes indications of at least a first candidate group of wireless nodes for positioning of the UE and a second candidate group of wireless nodes for positioning of the UE, the first candidate group of wireless nodes for positioning of the UE associated with a first area identifier (ID) and the second candidate group of wireless nodes for positioning of the UE associated with a second area ID;
establish a connection with a wireless node associated with the first area ID and the second area ID;
select at least one of the first area ID and the second area ID based on one or more selection parameters; and
perform a position estimation procedure associated with reference signals for positioning (RS-Ps) with two or more wireless nodes associated with the selected at least one area ID.

30. A network component, comprising:
a memory;
at least one transceiver; and
at least one processor communicatively coupled to the memory and the at least one transceiver, the at least one processor configured to:
determine assistance data for positioning that includes indications of at least a first second candidate group of wireless nodes for positioning of a user equipment (UE) and a second candidate group of wireless nodes for positioning of the UE, the first candidate group of wireless nodes for positioning of the UE associated with a first area identifier (ID) and the second candidate group of wireless nodes for positioning of the UE associated with a second area ID;
determine one or more selection parameters associated with UE-based area ID selection;
transmit, via the at least one transceiver, to the UE, the assistance data for positioning and the one or more selection parameters; and
receive, via the at least one transceiver, a report comprising measurement information associated with a position estimation procedure, wherein the report is based on the assistance data for positioning and the one or more selection parameters.
